(19) United States
(12) Patent Application Publication
(10) Pub. No.: US 2024/0384771 A1
(43) Pub. Date: Nov. 21, 2024

(54) COMPOSITE SPRING AND METHOD OF MANUFACTURING SAME

(71) Applicant: CARSOLIA COMPOSITES CORPORATION, Cookstown (CA)

(72) Inventor: Raymond BARTOLO, Woodbridge (CA)

(21) Appl. No.: 18/583,266

(22) Filed: Feb. 21, 2024

(30) Foreign Application Priority Data
May 19, 2023 (CA) 3200023

(51) Int. Cl. F16F 1/02

(52) U.S. Cl. CPC F16F 1/025; F16F 2224/02; F16F 2226/04

(57) ABSTRACT

Composite springs and methods for manufacturing such composite springs are provided. A spring includes a tube made from a fiber-reinforced composite material and having a longitudinal axis. The tube includes a first axial end having a closed shape that completely surrounds the longitudinal axis, a second axial end axially opposite the first axial end relative to the longitudinal axis, and one or more openings formed through a wall of the tube. The one or more openings define a resilient member of the spring.

### CROSS REFERENCE TO RELATED APPLICATION AND CLAIM OF PRIORITY

The present application claims priority to Canadian patent application no. 3,200,023 filed on May 19, 2023, the entire contents of which are hereby incorporated herein by reference.

### TECHNICAL FIELD

The disclosure relates generally to composite components, and more particularly to composite springs and associated methods of manufacturing.

### BACKGROUND

A helical or coil spring is a mechanical energy storage device comprising an elastic material formed in the shape of a helix that resiliently returns to its original length when unloaded. Under compression, the spring material undergoes torsion in which energy is stored and released when the compression is relieved. When the spring is disposed between two components, the spring may absorb shock or maintain a force between the two components.

Helical springs may be formed by winding a metallic (e.g., steel) wire in the form of a coil (e.g., “wound helical spring”). The length of the spring may be a function of both the diameter of the spring and the number of active turns in the coil. The properties of the helical spring depends on the length and diameter of the wire from which it is formed. Helical springs may be used in various applications such as automotive (e.g., in vehicle suspensions or in combustion engines for closing engine valves), recreational vehicles, powersport vehicles (e.g., all-terrain vehicles, snowmobiles and personal watercraft), aerospace applications (e.g., landing gears and suspensions for airplanes and helicopters), innerspring mattress coils, upholstery coils, and buckling springs in computer keyboards.

A metallic spring used in a vehicle suspension may be susceptible to corrosion especially when exposed to road salt. Also, existing manufacturing processes for wound helical springs can impart torsion in each coil of the spring as it is wound and this may render them susceptible to a bias in their deflection axis and may, in some situations, affect their ability to provide true linear movement. Improvement is desirable.

### SUMMARY

In one aspect, the disclosure describes a composite spring for a vehicle suspension. The composite spring comprises: a tube made from a fiber-reinforced composite material and having a longitudinal axis, the tube including: a first axial end having a closed shape that completely surrounds the longitudinal axis; a second axial end axially opposite the first axial end relative to the longitudinal axis; and one or more openings formed through a wall of the tube and disposed axially between the first axial end and the second axial end, a portion of the wall adjacent the one or more openings defining a resilient member of the spring.

The resilient member may be a coil.

The one or more openings may define a cellular structure and the resilient member may be part of the cellular structure.

The one or more openings may define a honeycomb structure and the resilient member may be part of the honeycomb structure.

The tube may have a circular radially-inner profile when viewed along the longitudinal axis.

The tube may have a circular radially-outer profile when viewed along the longitudinal axis.

The tube may have a non-circular radially-outer profile when viewed along the longitudinal axis.

The tube may have a polygonal radially-outer profile when viewed along the longitudinal axis.

The tube may have a non-circular radially-inner profile when viewed along the longitudinal axis.

The tube may have a non-circular radially-outer profile when viewed along the longitudinal axis.

The tube may have a polygonal radially-outer profile when viewed along the longitudinal axis.

The closed shape may be a first closed shape. The second axial end may have a second closed shape that completely surrounds the longitudinal axis.

The first axial end may be part of a first ring that completely surrounds the longitudinal axis.

The second axial end may be part of a second ring that completely surrounds the longitudinal axis.

The wall of the tube may include a plurality of stacked layers of fibers wrapped around the longitudinal axis. The layers may be stitched together.

The resilient member may include a coil. The coil may have a first helix angle. The layers may be stitched together along a stitch line having a second helix angle substantially equal to the first helix angle.

The fibers may be arranged in a weave in at least one of the layers.

The wall of the tube may include a pleated sheet of fibers wrapped around the longitudinal axis.

One or more pleats of the pleated sheet may be oriented at least partially radially relative to the longitudinal axis.

The pleated sheet of fibers may be a first pleated sheet of fibers. The wall of the tube may include a second pleated sheet of fibers overlaying and meshing with the first pleated sheet of fibers.

The wall of the tube may include an outer non-pleated sheet of fibers disposed radially outward of the pleated sheet of fibers and wrapped around the longitudinal axis.

The wall of the tube may include an inner non-pleated sheet of fibers disposed radially inward of the pleated sheet of fibers and wrapped around the longitudinal axis.

The wall of the tube may include a plurality of stiches extending through the pleated sheet of fibers.

The resilient member may include a coil. The coil may have a first helix angle. The wall of the tube may include stitches along a stitch line having a second helix angle substantially equal to the first helix angle.

Embodiments may include combinations of the above features.

In another aspect, the disclosure describes a vehicle including a composite spring as disclosed herein.

In another aspect, the disclosure describes a method of manufacturing a composite spring. The method comprises: forming a tubular precursor from fiber-reinforced composite material; and using a subtractive manufacturing process to form one or more openings through a wall of the tubular precursor to define a resilient member of the spring.

The subtractive manufacturing process may include water jet cutting.

Forming the tubular precursor may include: wrapping a pleated sheet of fibers pre-impregnated with a matrix material around a holder; and compression molding the pleated sheet to form the tubular precursor.

The pleated sheet may be a first pleated sheet of fibers. The method may include: wrapping a second pleated sheet of fibers pre-impregnated with the matrix material around the holder so that the second pleated sheet overlays and meshes with the first pleated sheet; and compression molding the first pleated sheet and the second pleated sheet together to form the tubular precursor.

At least some fibers in the first pleated sheet may be non-continuous and randomly-oriented.

Forming the tubular precursor may include wrapping an outer non-pleated sheet of fibers pre-impregnated with the matrix material around the holder and radially outward of the pleated sheet before the compression molding.

Forming the tubular precursor may include wrapping an inner non-pleated sheet of fibers pre-impregnated with the matrix material radially inward of the pleated sheet before the compression molding.

Forming the tubular precursor may includes: wrapping one or more layers of fibers pre-impregnated with a matrix material around a holder; stitching the one or more layers; and compression molding the one or more layers to form the tubular precursor.

The resilient member may be a coil. The coil may have a first helix angle. Stitching the one or more layers together may include stitching the one or more layers together along a stitch line having a second helix angle substantially equal to the first helix angle.

Forming the tubular precursor may include: wrapping one or more layers of fibers pre-impregnated with a matrix material around a holder; placing the holder with the one or more layers in a mold cavity by rotating a longitudinal axis of the holder about a pivot axis that is transverse to the longitudinal axis of the holder; and compression molding the one or more layers to form the tubular precursor.

Embodiments may include combinations of the above features.

In another aspect, the disclosure describes a compression molding apparatus for forming a tubular precursor to a composite spring. The compression molding apparatus comprises: a first mold portion; a second mold portion cooperating with the first mold portion to define a mold cavity, the first mold portion and the second mold portion being releasable from each other to open the mold cavity; a mandrel for holding the tubular precursor wrapped around the mandrel inside the mold cavity, the mandrel having a longitudinal axis and being pivotally connected to the second mold portion so that the mandrel is rotatable about a pivot axis that is transverse to the longitudinal axis of the mandrel; and a heat source for heating the tubular precursor during compression molding of the tubular precursor.

The heat source may include a heat-carrying fluid. The mandrel may include a passage formed therein for conveying the heat-carrying fluid.

The compression molding apparatus may comprise a metallic sleeve for holding the tubular precursor. The metallic sleeve may be configured to be fitted over the mandrel and be disposed between the tubular precursor and the mandrel.

The heat source may include a heat-carrying fluid. The mandrel may include a passage formed therein for conveying the heat-carrying fluid. The metallic sleeve may be in a conductive heat transfer engagement with the mandrel.

The compression molding apparatus may comprise a third mold portion cooperating with the first mold portion and the second mold portion to define the mold cavity. The third mold portion may be movable along the longitudinal axis of the mandrel to selectively lock and release the mandrel from a compression molding position.

Embodiments may include combinations of the above features.

In a further aspect, the disclosure describes a tubular manufacturing precursor to a composite spring, the precursor comprising a plurality of layers of fibers pre-impregnated with a matrix material and wrapped around an elongated holder having a longitudinal axis, the plurality of layers being stitched together.

The plurality of layers may be stitched together along a stitch line having a non-zero helix angle relative to the longitudinal axis.

In some embodiments, at least one of the plurality of layers has fibers that are oriented at the non-zero helix angle relative to the longitudinal axis.

In some embodiments, at least one of the plurality of layers is pleated.

Embodiments may include combinations of the above features.

In a further aspect, the disclosure describes a tubular manufacturing precursor to a composite spring, the precursor comprising a pleated sheet of fibers pre-impregnated with a matrix material and wrapped around an elongated holder having a longitudinal axis, the pleated sheet having a plurality of pleats oriented substantially radially relative to the longitudinal axis.

The pleated sheet may be a first pleated sheet. The tubular manufacturing precursor may include a second pleated sheet of fibers pre-impregnated with the matrix material and wrapped around the elongated holder. The second pleated sheet may overlay and meshing with the first pleated sheet.

The pleated sheet may be sandwiched between: an outer non-pleated sheet of fibers pre-impregnated with the matrix material, disposed radially outward of the pleated sheet and wrapped around the longitudinal axis; and an inner non-pleated sheet of fibers pre-impregnated with the matrix material, disposed radially inward of the pleated sheet of fibers and wrapped around the longitudinal axis.

Embodiments may include combinations of the above features

Further details of these and other aspects of the subject matter of this application will be apparent from the detailed description included below and the drawings.

### DESCRIPTION OF THE DRAWINGS

Reference is now made to the accompanying drawings, in which:

FIG. 1 shows a schematic representation of an automobile including a composite spring as described herein;

FIGS. 2A-2C are a perspective view, a front view and a top view respectively of an exemplary composite spring;

FIGS. 3A-3C are a perspective view, a front view and a top view respectively of another exemplary composite spring;

FIGS. 4A-4C are a perspective view, a front view and a top view respectively of another exemplary composite spring;

FIGS. 5A-5C are a perspective view, a front view and a top view respectively of another exemplary composite spring;

FIGS. 6A-6C are a perspective view, a front view and a top view respectively of another exemplary composite spring;

FIGS. 7A-7D are a perspective views of exemplary composite springs having different configurations of resilient members;

FIG. 8 is a flow diagram of a method of manufacturing a composite spring;

FIG. 9 is a perspective view of an exemplary uncured tubular precursor of the composite spring;

FIG. 10 is an enlarged view of region R1 of FIG. 9 of the tubular precursor of FIG. 9 including a plurality of layers of fibers pre-impregnated with matrix material;

FIG. 11A illustrates a pleated sheet of fibers pre-impregnated with matrix material for forming another tubular precursor;

FIG. 11B illustrates the pleated sheet wrapped around a holder;

FIGS. 12A-12C are enlarged views of region R1 for other exemplary tubular precursors of the composite spring including the pleated sheet of fibers pre-impregnated with matrix material;

FIGS. 13A-13C illustrate a stitching process applied to the tubular precursor of the composite spring;

FIG. 14A is a partial front view of the composite spring shown in FIGS. 2A-2C with stitch lines shown thereon;

FIG. 14B is an enlarged view of region R3 in FIG. 14A;

FIG. 15 is a partial cross-sectional view of the composite spring taken along line 15-15 in FIG. 2A showing stitches therein;

FIG. 16A is a schematic axial cross-sectional view of an exemplary apparatus for compression molding the tubular precursor where mold portions of the molding apparatus are shown in an open state;

FIG. 16B is a schematic axial cross-sectional view of the compression molding apparatus of FIG. 16A showing the mold portions in a closed state;

FIG. 16C is a schematic transverse cross-sectional view of the compression molding apparatus of FIG. 16A showing the mold portions in the closed state;

FIG. 17 is a perspective view of the tubular precursor of the composite spring shown together with a sleeve and a mandrel used during compression molding of the tubular precursor;

FIG. 18A is a schematic axial cross-sectional view of another exemplary apparatus for compression molding the tubular precursor where mold portions of the molding apparatus are shown in an open state;

FIG. 18B is a schematic axial cross-sectional view of the compression molding apparatus of FIG. 17A in a state of preparation for compression molding the tubular precursor;

FIG. 18C is a schematic axial cross-sectional view of the compression molding apparatus of FIG. 18A while compression molding the tubular precursor;

FIG. 18D is a schematic axial cross-sectional view of the compression molding apparatus of FIG. 18A after compression molding the tubular precursor;

FIG. 19A is a perspective view of another exemplary tubular precursor;

FIGS. 19B and 19C are transverse cross-sectional views of the tubular precursor of FIG. 19A illustrating a method of assembling and molding the tubular precursor of FIG. 19A; and

FIG. 20 is a perspective view of the cured tubular precursor after compression molding during a subtractive manufacturing process for forming openings in the tubular precursor.

### DETAILED DESCRIPTION

The following disclosure describes composite springs, precursors, methods and apparatus for manufacturing composite springs. In some embodiments, the composite springs described herein may provide improved corrosion resistance and reduced weight compared to other metallic springs. In some embodiments, the manufacturing processes described herein may facilitate tailoring of mechanical properties and/or shape of the composite springs. For example, the shape and size of the composite spring may be selected to tailor mechanical properties and/or spring behaviour/response, and/or based on installation constraints. For example, one or more axial ends of the composite spring may be shaped to facilitate installation of the composite spring and facilitate interfacing of the composite spring with the components between which the composite spring is installed.

In some embodiments, the composite springs described herein may exhibit a more linear axis of compression since, unlike steel springs, no torsional stress needs to be imparted to each coil during its manufacture. In some embodiments, the composite springs described herein may exhibit improved characteristics such as balance, precision and efficiency compared to some existing springs.

In some embodiments, the composite springs described herein may exhibit improved noise isolation and reduced transmission of road noise frequencies compared to some existing steel springs. For example, the composite springs described herein may be tailored to reduce noise, vibration and harshness (NVH) characteristics of a vehicle compared to existing steel springs.

In some embodiments, the composite springs described herein may be more visually appealing through the flexibility in selecting shapes and configurations of resilient members, and in selecting matrix materials of different colors (e.g., black) without needing to paint the composite springs.

Aspects of various embodiments are described through reference to the drawings.

The term “connected” may include both direct connection (in which two elements that are connected to each other contact each other) and indirect connection (in which at least one additional element is located between the two elements). The term “substantially” as used herein may be applied to modify any quantitative representation which could permissibly vary without resulting in a change in the basic function to which it is related.

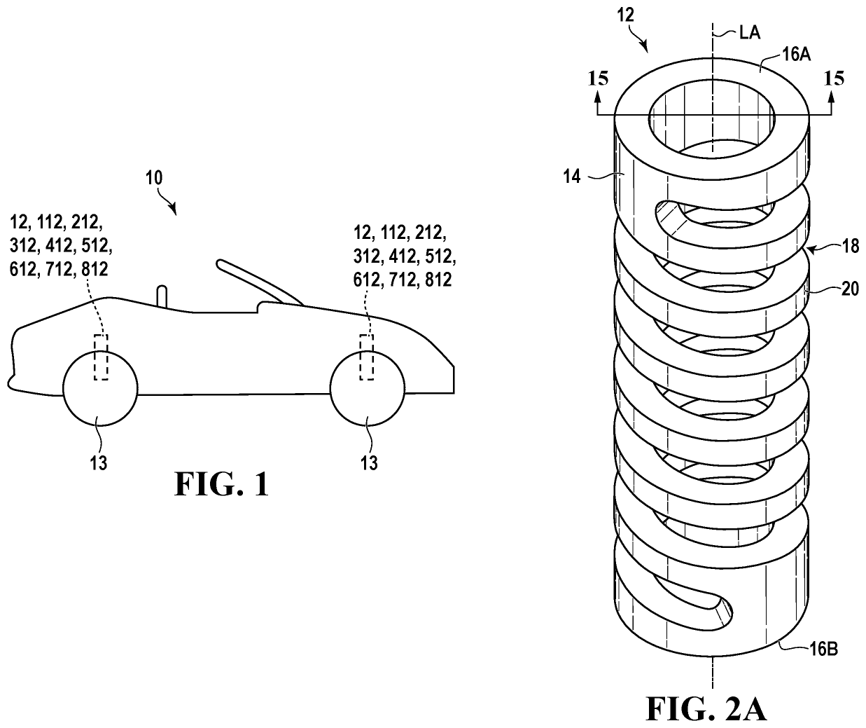

FIG. 1 shows a schematic representation of vehicle 10 including composite spring 12, 112, 212, 312, 412, 512, 612, 712, 812 (referred generally herein as “spring 12”) described herein. Spring 12 may be part of a suspension of vehicle 10. For example, spring 12 may be operatively installed between a (e.g., front or rear) ground-engaging wheel 13 of vehicle 10 and a frame/chassis of vehicle 10. In various embodiments, vehicle 10 may include one or more springs 12. In some embodiments, vehicle 10 may be an automobile. In some embodiments, vehicle 10 may be a pick-up truck, a recreational vehicle, an aircraft, a powersport vehicle such as an all-terrain vehicle, a snowmobile or a motorcycle for example. Spring 12 may be manufactured in a wide range of shapes and sizes for a wide variety of applications. The use of spring 12 in vehicle 10 is illustrated as a non-limiting example.

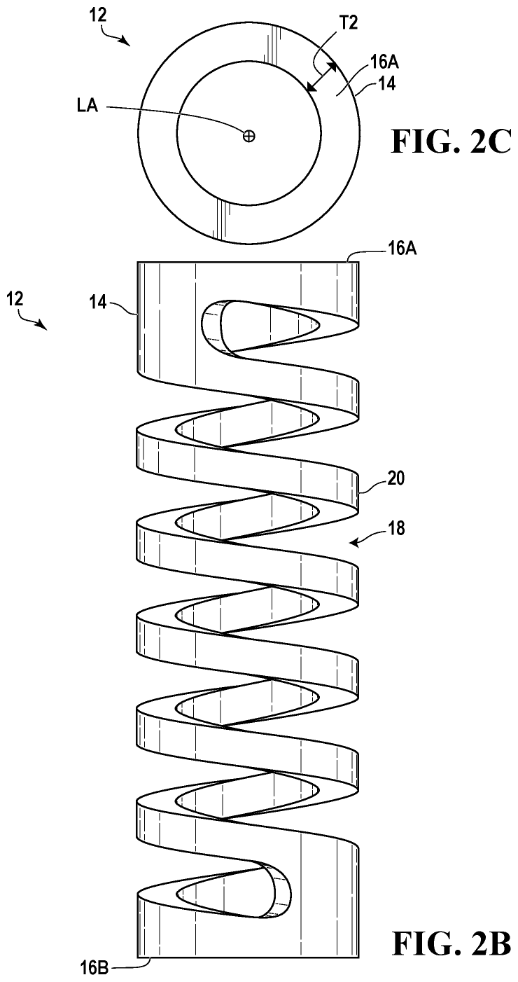

FIGS. 2A-2C are a perspective view, a front view and a top view respectively of spring 12. Spring 12 may be configured as a (i.e., helical) coil spring including one or more turns. Spring 12 may include a hollow, fenestrated and generally tubular body referenced herein as “tube 14” made from a fiber-reinforced composite material and having longitudinal axis LA. Tube 14 may include first axial end 16A and second axial end 16B axially opposite first axial end 16A relative to longitudinal axis LA. First axial end 16A and/or second axial end 16B may each have a closed shape that completely surrounds longitudinal axis LA. In some embodiments, first axial end 16A and/or second axial end 16B may each be an annulus (e.g., as shown in FIG. 2C) completely surrounding longitudinal axis LA. In some embodiments, first axial end 16A and/or second axial end 16B may each be part of a ring completely surrounding longitudinal axis LA. In some embodiments, first axial end 16A and second axial end 16B may have substantially identical shapes (e.g., mirror images of each other) and configurations. Alternatively, first axial end 16A and second axial end 16B may have different shapes and configurations from each other depending on installation constraints for spring 12.

Spring 12 may include one or more openings 18 formed in a wall of tube 14 and disposed axially between first axial end 16A and second axial end 16B to define one or more resilient members 20 (referred hereinafter in the singular) of spring 12. Opening(s) 18 may extend radially through the wall of tube 14. In some embodiments, resilient member 20 includes one or more wall portions adjacent (e.g., between) openings(s) 18 and is configured to facilitate axial compression and/or extension of spring 12 along longitudinal axis LA. In some embodiments, resilient member 20 is a coil. In various embodiments, the coil may have a cross-sectional profile in a plane parallel to and containing longitudinal axis LA that is substantially uniform along at least a majority of the axial length of the coil. Alternatively, the cross-sectional profile of the coil may be non-uniform (i.e., may vary) along at least a majority of the axial length of the coil. In various embodiments, thickness T2 (shown in FIG. 2C) of the wall of spring 12 may be uniform along longitudinal axis LA, or may vary along longitudinal axis LA to provide a multi-rate spring. In some embodiments, the coil may have a rectangular (e.g., square) or other cross-sectional profile.

In reference to FIG. 2C, tube 14 (and spring 12) may have a circular radially-inner profile when viewed along longitudinal axis LA. In some embodiments, tube 14 (and spring 12) may have a circular radially-outer profile when viewed along longitudinal axis LA.

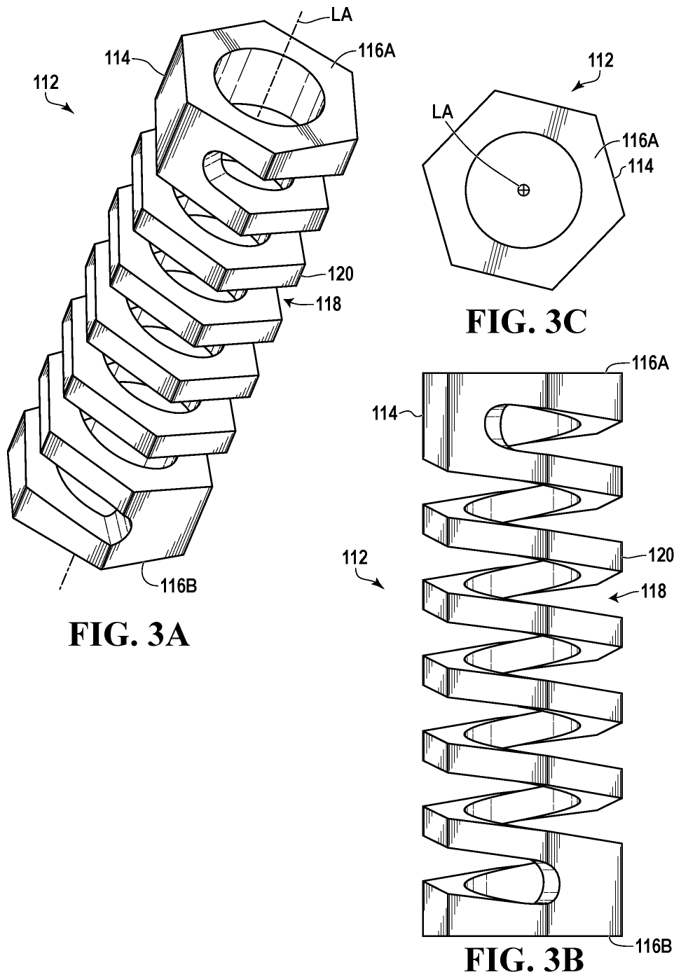

FIGS. 3A-3C are a perspective view, a front view and a top view respectively of another exemplary composite spring 112. Spring 112 may include elements of spring 12. Like elements have been identified using reference numerals that have been incremented by 100. Spring 112 may be configured as a coil spring. Spring 112 may include fenestrated tube 114 made from a fiber-reinforced composite material and having longitudinal axis LA. Tube 114 may include first axial end 116A and second axial end 116B axially opposite first axial end 116A relative to longitudinal axis LA. Spring 112 may include one or more openings 118 formed in tube 114 and disposed axially between first axial end 116A and second axial end 116B to define one or more resilient members 120 of spring 112. Opening(s) 118 may extend radially through a wall of tube 114. In some embodiments, resilient member(s) 120 may be configured to facilitate axial compression and/or extension of spring 112 along longitudinal axis LA. In reference to FIG. 3C, tube 114 (and spring 112) may have a circular radially-inner profile when viewed along longitudinal axis LA. In some embodiments, tube 114 (and spring 112) may have a non-circular radially-outer profile when viewed along longitudinal axis LA. For example, tube 114 (and spring 112) may have a polygonal (e.g., hexagonal) radially-outer profile when viewed along longitudinal axis LA.

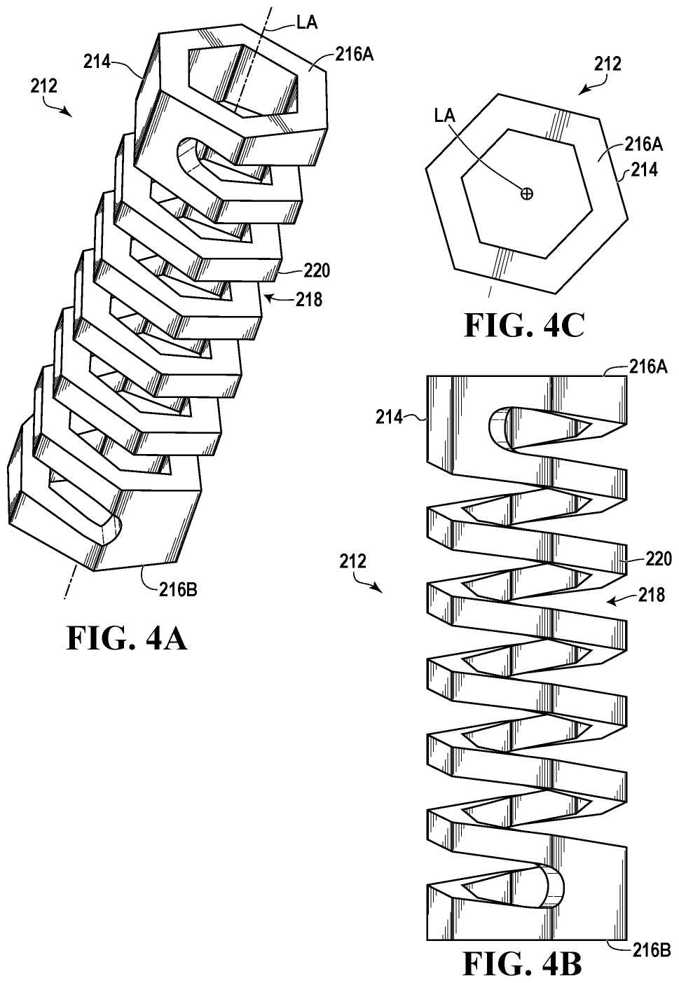

FIGS. 4A-4C are a perspective view, a front view and a top view respectively of another exemplary composite spring 212. Spring 212 may include elements of spring 12. Like elements have been identified using reference numerals that have been incremented by 200. Spring 212 may be configured as a coil spring. Spring 212 may include fenestrated tube 214 made from a fiber-reinforced composite material and having longitudinal axis LA. Tube 214 may include first axial end 216A and second axial end 216B axially opposite first axial end 216A relative to longitudinal axis LA. Spring 212 may include one or more openings 218 formed in tube 214 and disposed axially between first axial end 216A and second axial end 216B to define one or more resilient members 220 of spring 212. Opening(s) 218 may extend radially through a wall of tube 214. In some embodiments, resilient member(s) 220 may be configured to facilitate axial compression and/or extension of spring 212 along longitudinal axis LA. In reference to FIG. 4C, tube 214 (and spring 212) may have a non-circular radially-inner profile when viewed along longitudinal axis LA. For example, tube 214 (and spring 212) may have a polygonal (e.g., hexagonal) radially-inner profile when viewed along longitudinal axis LA. In some embodiments, tube 214 (and spring 212) may have a non-circular radially-outer profile when viewed along longitudinal axis LA. For example, tube 214 (and spring 212) may have a polygonal (e.g., hexagonal) radially-outer profile when viewed along longitudinal axis LA.

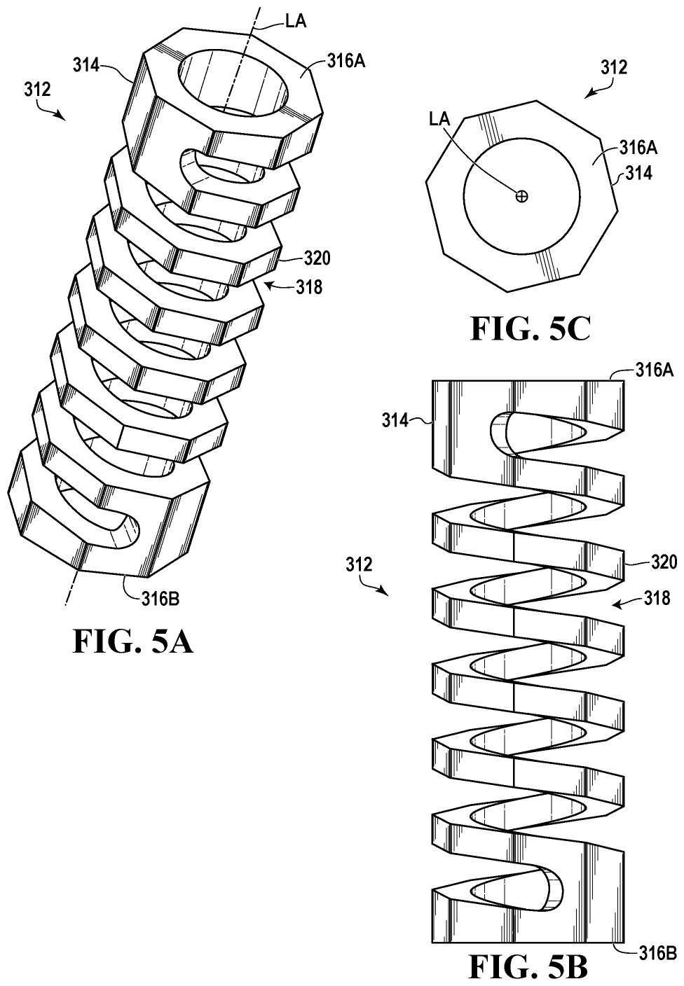

FIGS. 5A-5C are a perspective view, a front view and a top view respectively of another exemplary composite spring 312. Spring 312 may include elements of spring 12. Like elements have been identified using reference numerals that have been incremented by 300. Spring 312 may be configured as a coil spring. Spring 312 may include fenestrated tube 314 made from a fiber-reinforced composite material and having longitudinal axis LA. Tube 314 may include first axial end 316A and second axial end 316B axially opposite first axial end 316A relative to longitudinal axis LA. Spring 312 may include one or more openings 318 formed in tube 314 and disposed axially between first axial end 316A and second axial end 316B to define one or more resilient members 320 of spring 312. Opening(s) 318 may extend radially through a wall of tube 314. In some embodiments, resilient member(s) 320 may be configured to facilitate axial compression and/or extension of spring 312 along longitudinal axis LA. In reference to FIG. 5C, tube 314 (and spring 312) may have a circular radially-inner profile when viewed along longitudinal axis LA. In some embodiments, tube 314 (and spring 312) may have a non-circular radially-outer profile when viewed along longitudinal axis LA. For example, tube 314 (and spring 312) may have a polygonal (e.g., octagonal) radially-outer profile when viewed along longitudinal axis LA.

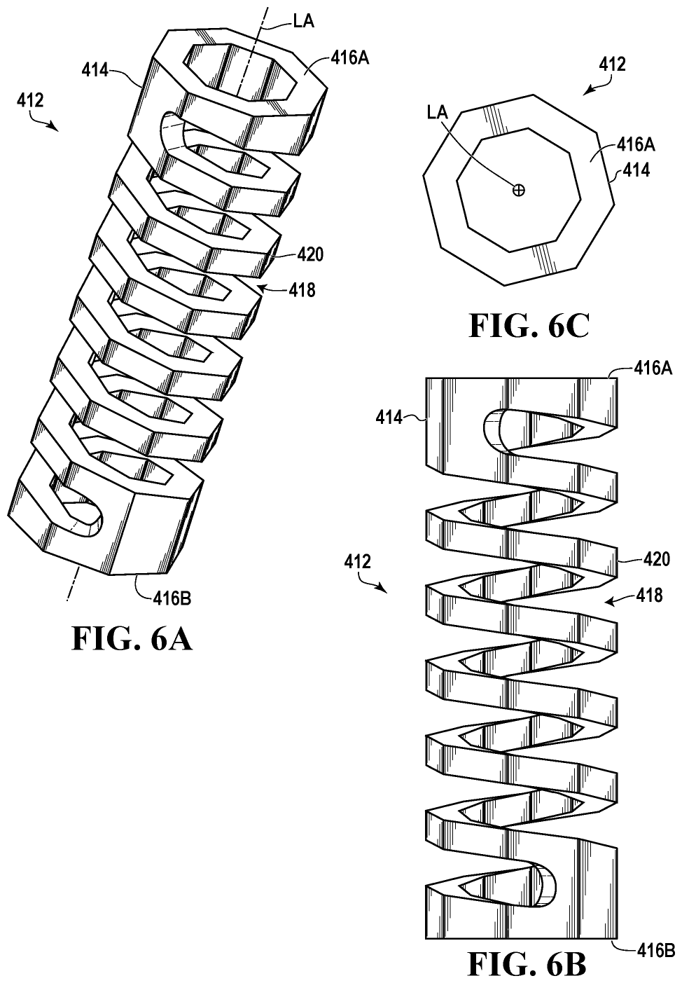

FIGS. 6A-6C are a perspective view, a front view and a top view respectively of another exemplary composite spring 412. Spring 412 may include elements of spring 12. Like elements have been identified using reference numerals that have been incremented by 400. Spring 412 may be configured as a coil spring. Spring 412 may include fenestrated tube 414 made from a fiber-reinforced composite material and having longitudinal axis LA. Tube 414 may include first axial end 416A and second axial end 416B axially opposite first axial end 416A relative to longitudinal axis LA. Spring 412 may include one or more openings 418 formed in tube 414 and disposed axially between first axial end 416A and second axial end 416B to define one or more resilient members 420 of spring 412. Opening(s) 418 may extend radially through a wall of tube 414. In some embodiments, resilient member(s) 420 may be configured to facilitate axial compression and/or extension of spring 412 along longitudinal axis LA. In reference to FIG. 4C, tube 414 (and spring 412) may have a non-circular radially-inner profile when viewed along longitudinal axis LA. For example, tube 414 (and spring 412) may have a polygonal (e.g., octagonal) radially-inner profile when viewed along longitudinal axis LA. In some embodiments, tube 414 (and spring 412) may have a non-circular radially-outer profile when viewed along longitudinal axis LA. For example, tube 414 (and spring 412) may have a polygonal (e.g., octagonal) radially-outer profile when viewed along longitudinal axis LA.

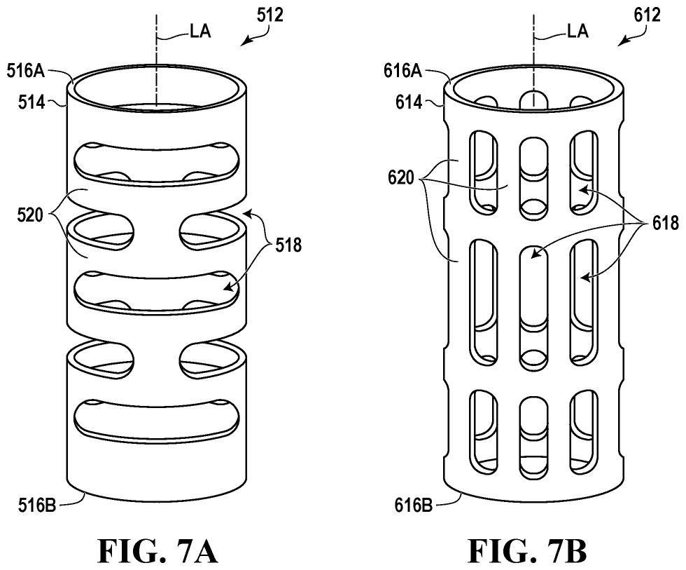

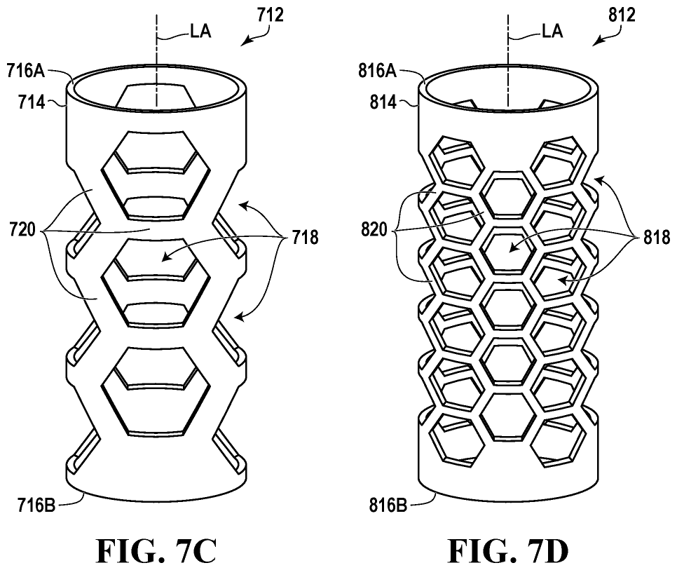

FIG. 7A is a perspective schematic view of another exemplary composite spring 512. Spring 512 may include elements of spring 12. Like elements have been identified using reference numerals that have been incremented by 500. Spring 512 may include fenestrated tube 514 made from a fiber-reinforced composite material and having longitudinal axis LA. Tube 514 may include first axial end 516A and second axial end 516B axially opposite first axial end 516A relative to longitudinal axis LA. Spring 512 may include one or more openings 518 formed in tube 514 and disposed axially between first axial end 516A and second axial end 516B to define one or more resilient members 520 of spring 512. Opening(s) 518 may extend radially through a wall of tube 514. In some embodiments, resilient member(s) 520 may be configured to facilitate axial compression and/or extension of spring 512 along longitudinal axis LA. For example, circumferentially elongated opening(s) 518 (slots) may define resilient member(s) 520 that may be part of a cellular structure. In various embodiments, resilient member(s) 520 may include one or more flexible (e.g., elongated) frame members (e.g., beam(s), post(s)).

FIG. 7B is a perspective schematic view of another exemplary composite spring 612. Spring 612 may include elements of spring 12. Like elements have been identified using reference numerals that have been incremented by 600. Spring 612 may include fenestrated tube 614 made from a fiber-reinforced composite material and having longitudinal axis LA. Tube 614 may include first axial end 616A and second axial end 616B axially opposite first axial end 616A relative to longitudinal axis LA. Spring 612 may include one or more openings 618 formed in tube 614 and disposed axially between first axial end 616A and second axial end 616B to define one or more resilient members 620 of spring 612. Opening(s) 618 may extend radially through a wall of tube 514. In some embodiments, resilient member(s) 620 may be configured to facilitate axial compression and/or extension of spring 612 along longitudinal axis LA. For example, axially elongated opening(s) 618 (slots) may define resilient member(s) 620 that may be part of a cellular structure. In various embodiments, resilient member(s) 620 may include one or more flexible (e.g., elongated) frame members (e.g., beam(s), post(s)).

FIG. 7C is a perspective schematic view of another exemplary composite spring 712. Spring 712 may include elements of spring 12. Like elements have been identified using reference numerals that have been incremented by 700. Spring 712 may include fenestrated tube 714 made from a fiber-reinforced composite material and having longitudinal axis LA. Tube 714 may include first axial end 716A and second axial end 716B axially opposite first axial end 716A relative to longitudinal axis LA. Spring 712 may include one or more openings 718 formed in tube 714 and disposed axially between first axial end 716A and second axial end 716B to define one or more resilient members 720 of spring 712. Opening(s) 718 may extend radially through a wall of tube 714. In some embodiments, resilient member(s) 720 may be configured to facilitate axial compression and/or extension of spring 712 along longitudinal axis LA. For example, opening(s) 718 may define resilient member(s) 720 that may be part of a cellular structure. For example, polygonal opening(s) 718 may define resilient member(s) 720 that may be part of a relatively coarse honeycomb structure. In various embodiments, resilient member(s) 720 may include one or more flexible (e.g., elongated) frame members (e.g., beam(s), post(s)).

FIG. 7D is a perspective schematic view of another exemplary composite spring 812. Spring 812 may include elements of spring 12. Like elements have been identified using reference numerals that have been incremented by 800. Spring 812 may include fenestrated tube 814 made from a fiber-reinforced composite material and having longitudinal axis LA. Tube 814 may include first axial end 816A and second axial end 816B axially opposite first axial end 816A relative to longitudinal axis LA. Spring 812 may include one or more openings 818 formed in tube 814 and disposed axially between first axial end 816A and second axial end 816B to define one or more resilient members 820 of spring 812. Opening(s) 818 may extend radially through a wall of tube 814. In some embodiments, resilient member(s) 820 may be configured to facilitate axial compression and/or extension of spring 812 along longitudinal axis LA. For example, opening(s) 818 may define resilient member(s) 820 that may be part of a cellular structure. For example, polygonal opening(s) 818 may define resilient member(s) 820 that may be part of a relatively fine honeycomb structure. In various embodiments, resilient member(s) 820 may include one or more flexible (e.g., elongated) frame members (e.g., beam(s), post(s)).

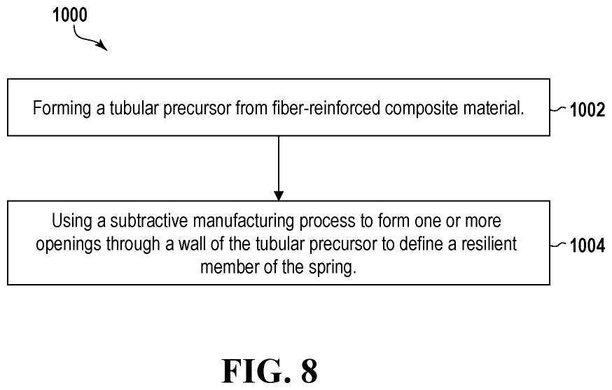

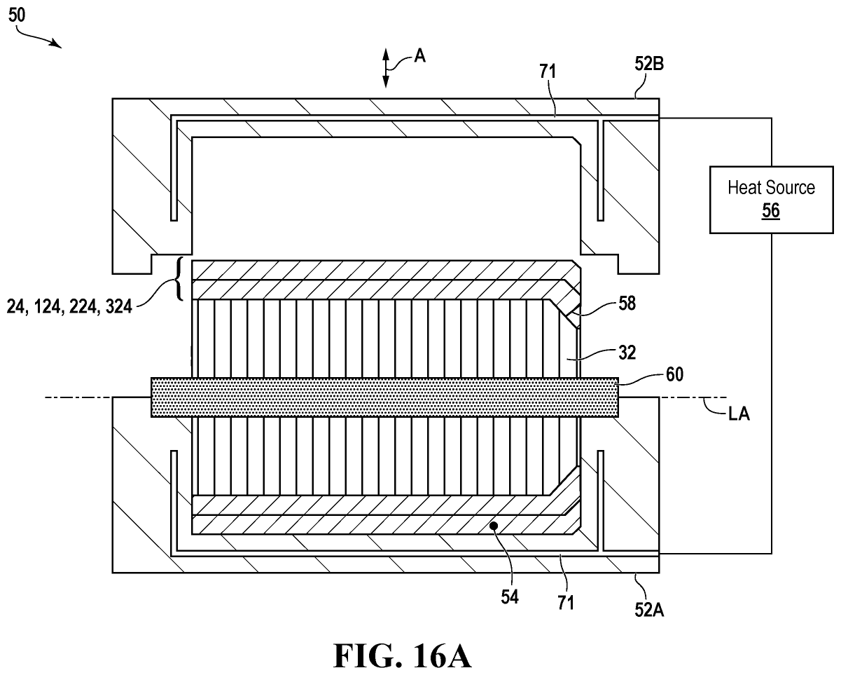

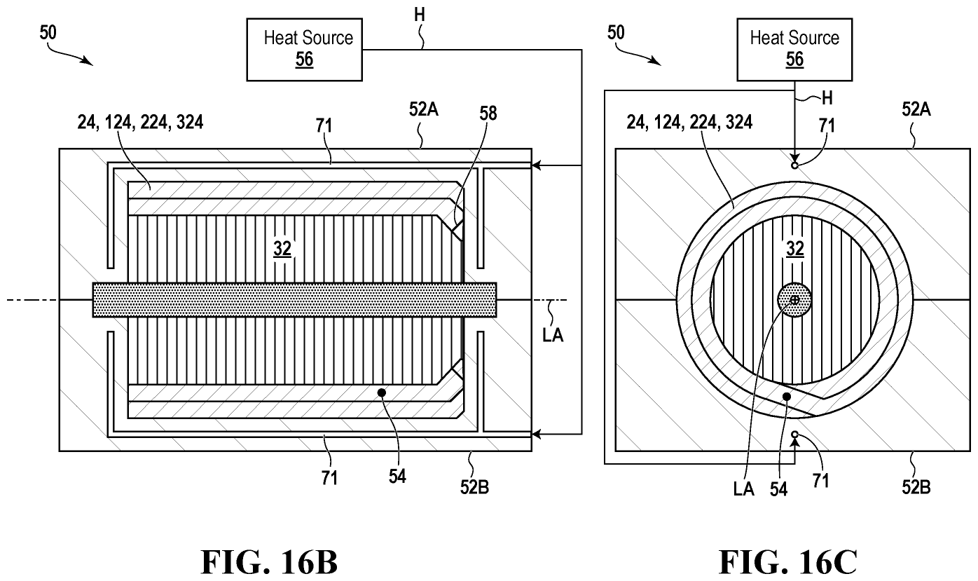

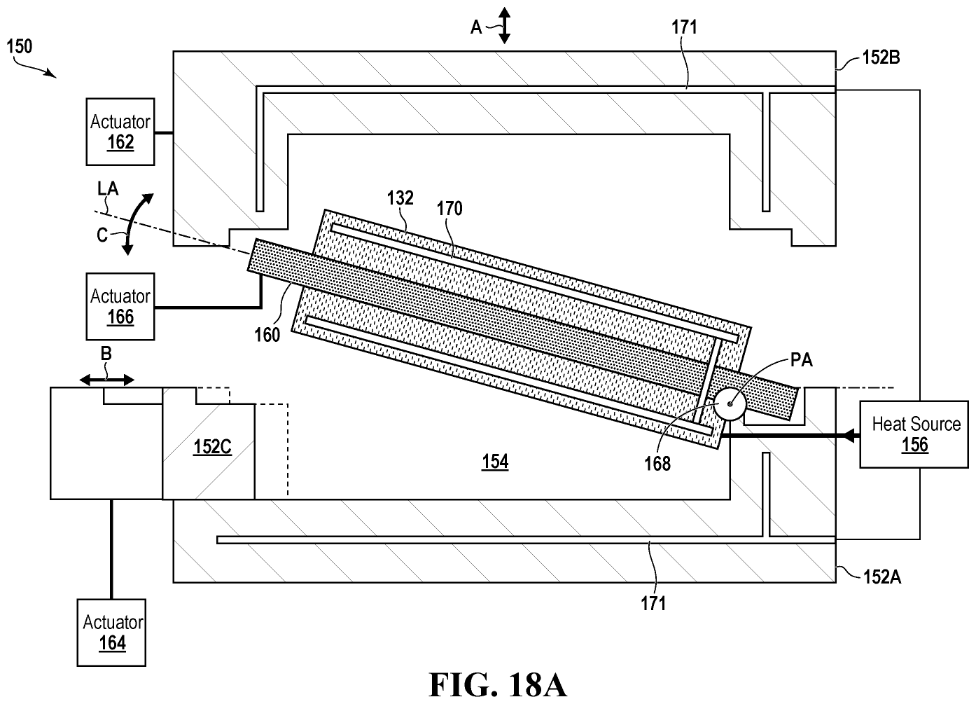

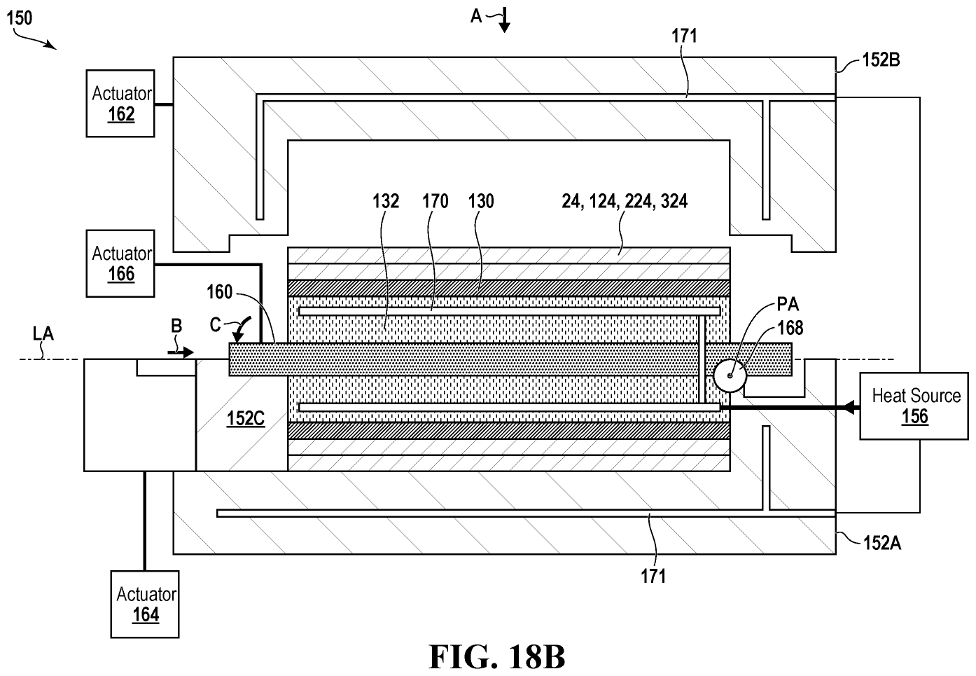

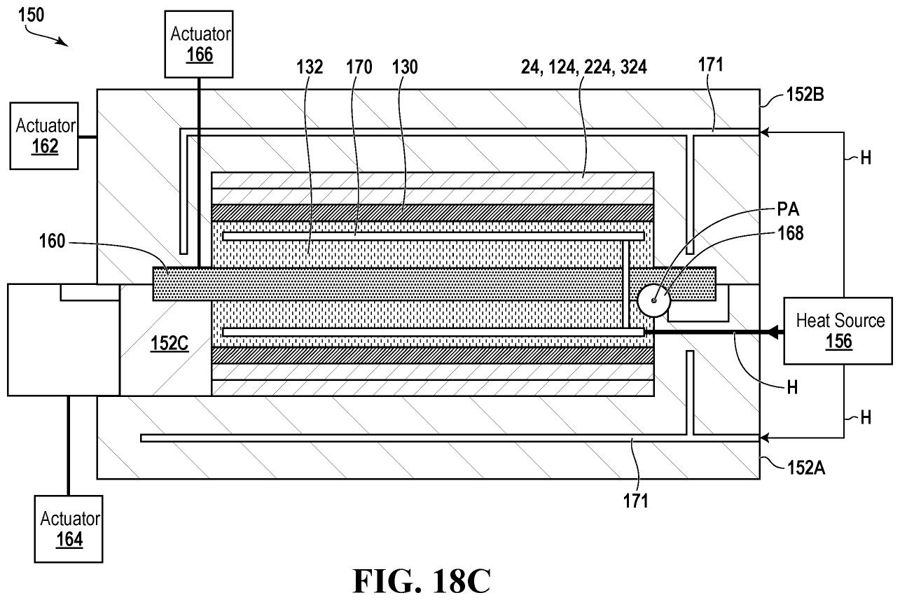

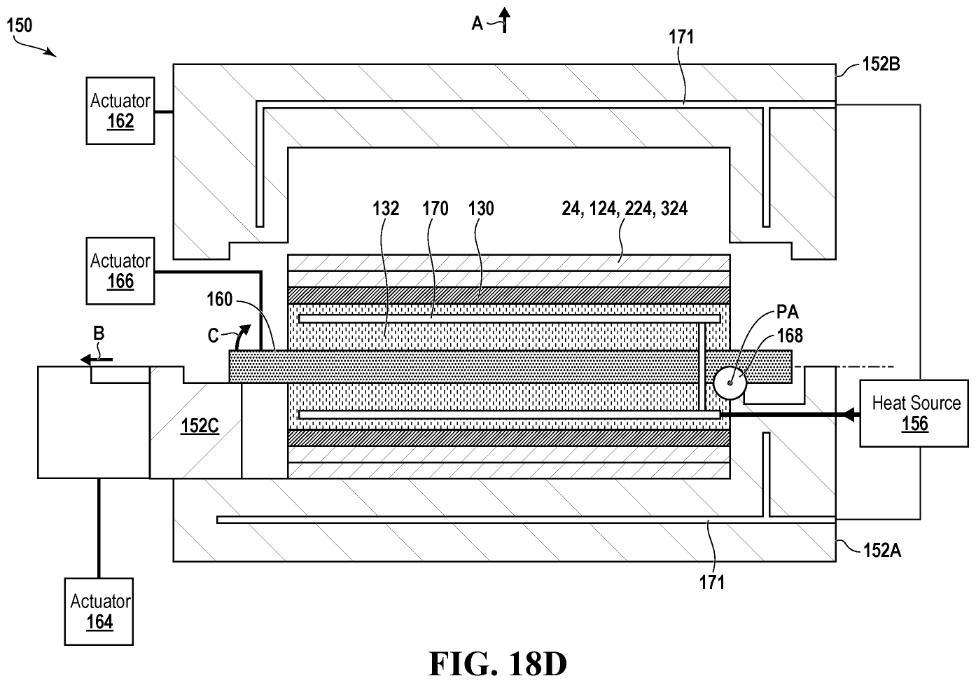

FIG. 8 is a flow diagram of a method 1000 of manufacturing composite spring 12 or another composite spring. Method 1000 may be performed using compression molding apparatus 50, 150 (shown in FIGS. 16A-16C and 18A-18D) described below. Aspects of spring 12 and/or of apparatus 50, 150 may be incorporated in method 1000. In various embodiments, method 1000 includes:
forming tubular (e.g., cylindrical, annular) precursor 24 from fiber-reinforced composite material (block 1002); and
using a subtractive manufacturing process to form one or more openings 18, 118, 218, 318, 418, 518, 618, 718, 818 (referenced generally hereinafter as “openings 18”) through a wall of tubular precursor 24 to define resilient member(s) 20, 120, 220, 320, 420, 520, 620, 720, 820 (referenced generally hereinafter as “resilient member 20”) of spring 12 (block 1004).

Aspects of method 1000 are described below in reference to the subsequent figures.

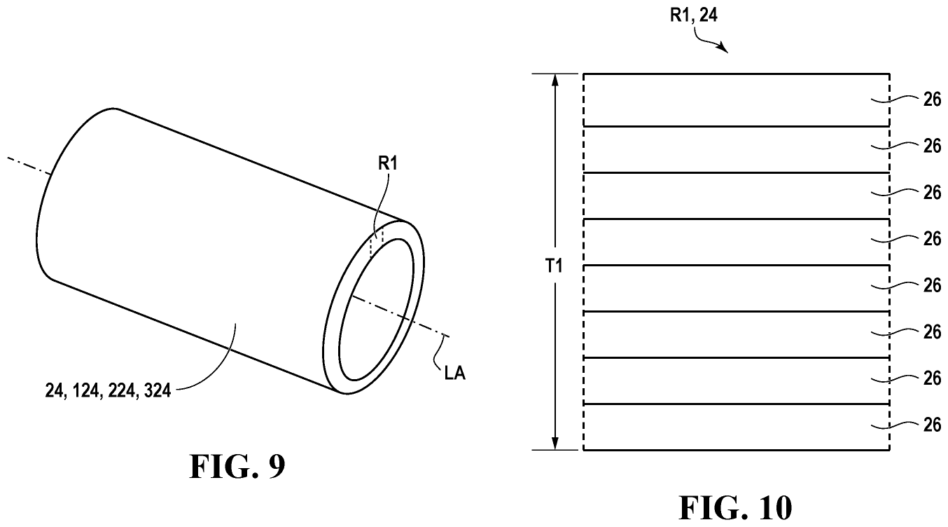

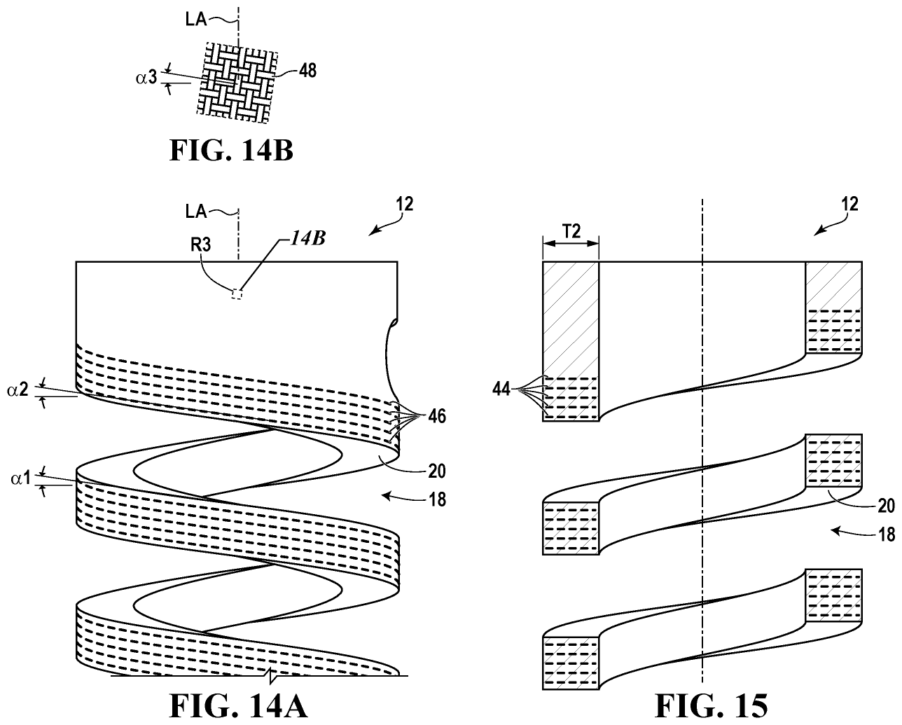

FIG. 9 is a perspective view of an exemplary uncured tubular precursor 24, 124, 224, 324 (referenced generally herein as “precursor 24”) of spring 12. Precursor 24 may also be referenced as a “blank”. Precursor 24 may be an unfinished item that is obtained during the process of manufacturing spring 12. For example, precursor 24 may be subjected to compression molding and then spring 12 may be obtained by forming openings 18 through a wall of precursor 24 using a material removal (i.e., subtractive) process. For example, cured precursor 24 may define the overall shape of spring 12 and may have the same longitudinal axis LA. In various embodiments, cured precursor 24 may have the same or a different wall thickness T2 (shown in FIG. 15) as spring 12.

Precursor 24 may be manufactured using a suitable composite manufacturing technique. In various embodiments, precursor 24 may be formed of a (e.g., carbon or glass) fiber-reinforced composite material including a thermoplastic matrix material such as a homopolymer, polyoxymethylene (POM) (also known as acetal), polyacetal, and polyformaldehyde. In some embodiments, POM sold under the trade name DELRIN by the DUPONT CHEMICAL COMPANY may exhibit suitable strength, hardness, rigidity and stiffness, low friction and dimensional stability to low temperatures approaching substantially about −40° C., may be suitable. In various embodiments, precursor 24 may be formed of a (e.g., carbon or glass) fiber-reinforced composite material including a thermosetting matrix material.

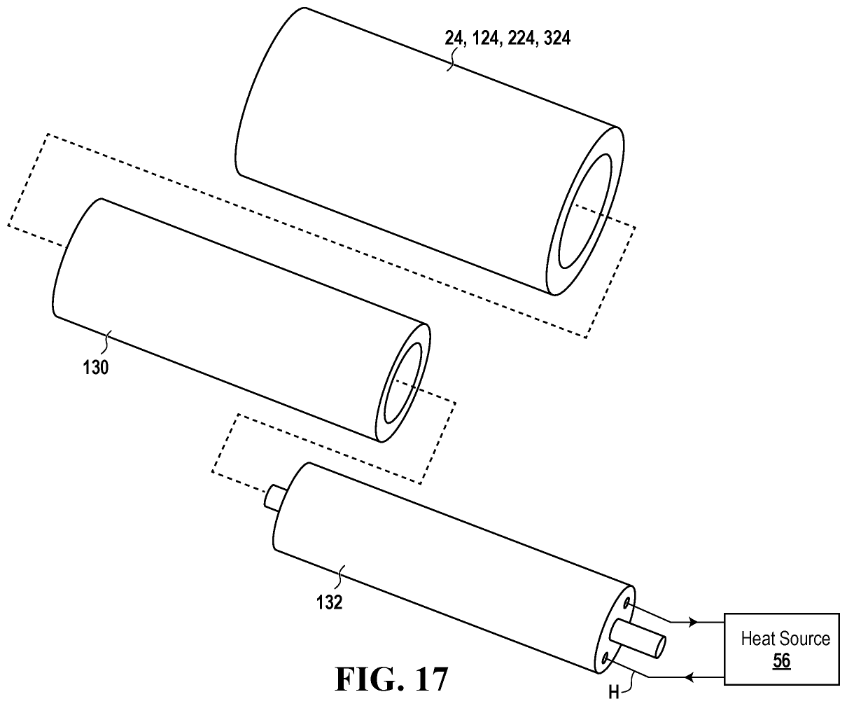

FIG. 10 is an enlarged schematic view of region R1 of precursor 24A shown in FIG. 9. In some embodiments, precursor 24A may be formed using of layers 26 of fibers pre-impregnated with a partially cured matrix material (also referenced herein as “pre-preg”) that are stacked together (i.e., superimposed) and wrapped around longitudinal axis LA, and then compression molded. Fore example, layers 26 may be initially provided in sheet form and stacked and/or wound around an elongated (e.g., cylindrical) holder such as sleeve 130 (shown in FIG. 17) or mandrel 32 (shown in FIG. 17) to obtain the tubular shape. In some embodiments, layers 26 may each be a suitable pre-preg sheet. In various embodiments, one or more layers 26 may include (e.g., carbon or glass) fibers that are relatively short and randomly oriented, continuous and unidirectional, and/or arranged in a suitable weave pattern.

In some embodiments, one or more layers 26 may include sheet molding compound (SMC) that includes pre-preg carbon and/or glass fibers. In various embodiments, the SMC may be glass-fiber reinforced polyester material. In some embodiments, one or more layers 26 may include a carbon fiber sheet molding compound (CF-SMC) that is ready to mold and suitable for compression molding.

In some embodiments, CF-SMC may include chopped carbon fibers (i.e., carbon fiber tows cut from pre-preg unidirectional tape). The length and distribution of the carbon fibers may be relatively regular, homogeneous and constant. As for the matrix material, the CF-SMC may include a suitable thermosetting resin such as polyester, vinyl ester or epoxy for example. In some embodiments, one or more layers 26 may include a Forged Molding Compound™ such as product numbers PTE130N131 and TCS-0021-18E sold under the trade name MITSUBISHI CHEMICAL may be suitable. The Forged Molding Compound™ may be provided in sheet form including carbon fiber prep-preg including a random arrangement of short (i.e., cut, non-continuous) fibers to facilitate fluidity in molding intricate shapes.

In some embodiments, one or more layers 26 may include a carbon fiber fabric (i.e., cloth) pre-preg where continuous fibers take the form of a weave and the matrix is used to bond them together and/or to other components during manufacture. The matrix material may be a thermosetting resin that partially cured (e.g., B-stage material) to allow easy handling. The carbon fibers in the pre-preg fabric may be arranged (woven) in a weave in which two distinct sets of continuous fibers are interlaced at right angles. In some embodiments, a suitable pre-preg carbon fiber fabric may be of a type sold under the trade name MITSUBISHI CHEMICAL.

In some embodiments, one or more layers 26 may include carbon fiber arranged in a unidirectional (UD) tape or sheet including a thermosetting epoxy matrix, and which is suitable for compression molding. In some embodiments, product numbers PYROFIL™ 360 and PYROFIL™ 361 sold under the trade name MITSUBISHI CHEMICAL may be suitable.

In some embodiments, all layers 26 may be of the same type of material (e.g., sheets) at the same fiber orientation relative to longitudinal axis LA. In some embodiments, all layers 26 may be of the same type of material but some sheets may have different fiber orientations relative to longitudinal axis LA depending on the mechanical properties desired for spring 12. In some embodiments layers 26 may include different types of pre-preg sheets. For example, in some embodiments, layers 26 may be 100% CF-SMC, partially CF-SMC with some UD sheet, or 100% UD sheet, depending on the mechanical properties (e.g., spring rate) desired.

In some embodiments, the sheet(s) that define layers 26 may be substantially flat and pliable and may have a thickness between 2 mm and 3 mm. In some embodiments, a plurality of layers 26 may be required to achieve a desired pre-compression thickness T1 of the wall of the uncured precursor 24. In some embodiments, a plurality of layers 26 may be wrapped around the holder to obtain a pre-compression thickness T1 that is between 5 mm and 25 mm for example. Alternatively, a sheet of a suitable thickness may be selected to correspond to the desired pre-compression thickness T1 so that a single (only one) layer 26 is required to form precursor 24. In some situations, the pre-preg sheet(s) used to form layer(s) 26 may be cut to a desired shape, length and width to facilitate wrapping around the holder. A non-uniform thickness T1 may be achieved through partial/trimmed layers 26 of different axial lengths and/or axial positions on the uncured precursor 24.

Precursor 24 as shown may subsequently proceed to a compression molding step. Optionally, stitching may be applied to precursor 24 before compression molding as explained below.

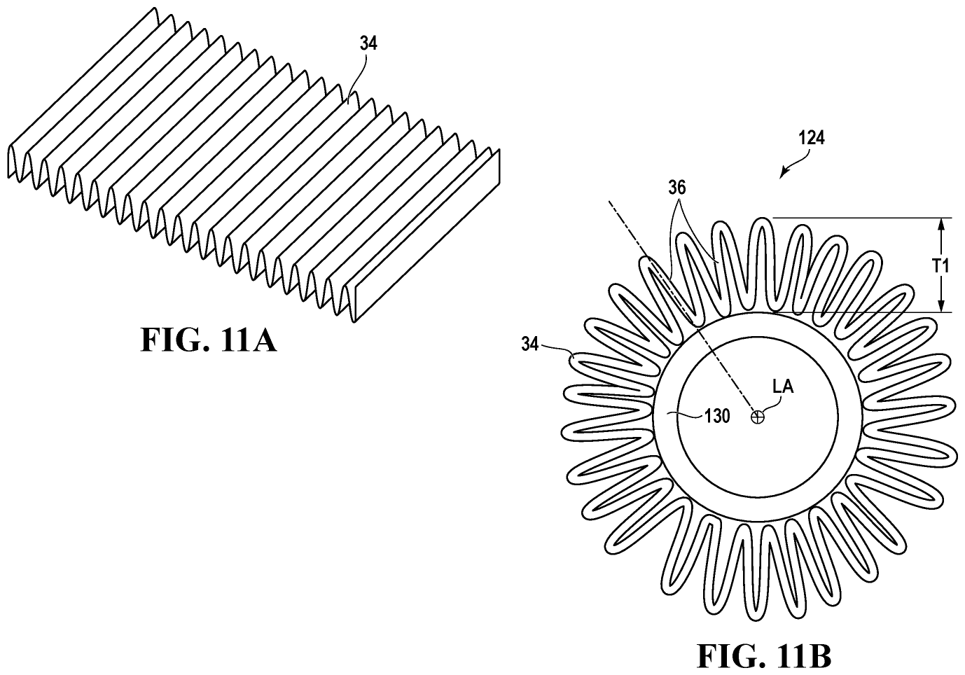

FIG. 11A illustrates a pleated pre-preg sheet 34 that may be used to form any one of precursors 124, 224, 324. Pleated pre-preg sheet 34 may contain (e.g., glass or carbon) fibers and a suitable (e.g., thermoplastic or thermosetting) matrix material of any type disclosed above or of another type. Pleated pre-preg sheet 34 may be pleated using known or other pleating equipment. For example, pleated pre-preg sheet 34 may be pleated using a servo knife pleating machine such as machine model number MFM-2-S sold under the trade name ROTH. In some embodiments, the use of pleated pre-preg sheet 34 for forming spring 12 may promote an improved resistance to torsional shear stresses that may be experienced by spring 12 during use.

FIG. 11B schematically illustrates pleated pre-preg sheet 34 wrapped around a holder such as sleeve 130, which may be placed over mandrel 132. Alternatively, pleated pre-preg sheet 34 may be wrapped directly onto mandrel 32. In some embodiments, pleated pre-preg sheet 34 may be formed to have thickness T1, which may substantially correspond to the pre-compression radial thickness T1 (shown in FIG. 11B) of the wall of precursor 124. Pleated pre-preg sheet 34 may be wrapped onto sleeve 130 so that adjacent/neighbouring pleats 36 contact each other. For example, pleated pre-preg sheet 34 may be wrapped so that pleats 36 are relatively tight together. Pleated pre-preg sheet 34 may be wrapped around longitudinal axis LA so that pleats 36 are oriented substantially radially relative to longitudinal axis LA. In some embodiments, opposite ends of pleated pre-preg sheet 34 may meet and overlap each other when pleated pre-preg sheet 34 is wrapped around longitudinal axis LA.

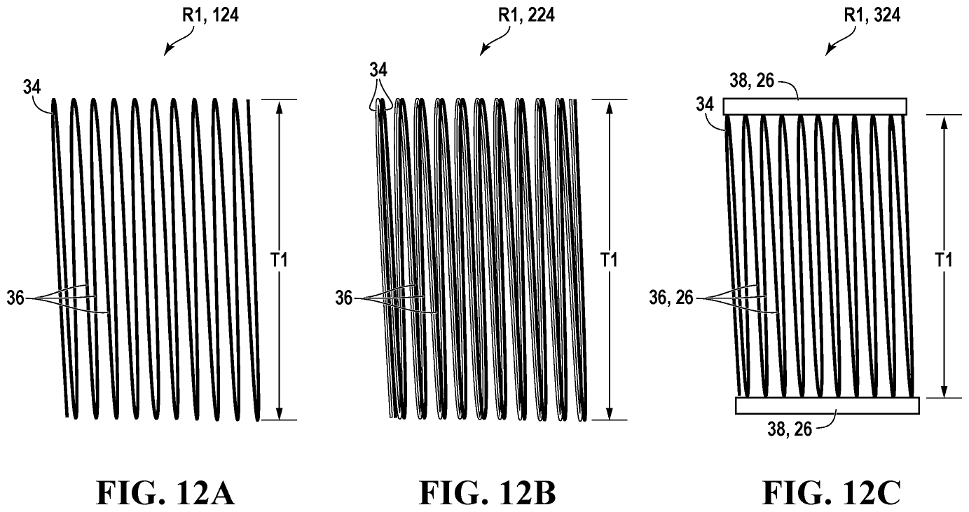

FIGS. 12A-12C are schematic enlarged views of region R1 in FIG. 9 of precursors 124, 224 and 334 respectively. FIG. 12A shows precursor 124 showing a single pleated pre-preg sheet 34 that is wrapped around longitudinal axis LA. Faces of adjacent pleats 36 may be disposed relatively close to each other or may contact each other.

FIG. 12B shows an embodiment where two pleated pre-preg sheets 34 are wrapped around longitudinal axis LA. Two or more pleated pre-preg sheets 34 may be stacked together to form a multi-layer pleated pre-preg sheet. The two pleated pre-preg sheets 34 may be pleated together in a single pleating operation. The two pleated pre-preg sheets 34 may be pleated and arranged so that one pleated pre-preg sheet 34 overlays the other pleated pre-preg sheet 34 and that pleats 36 of the two pleated pre-preg sheets 34 mesh with each other.

The fiber orientations and the types of pleated pre-preg sheets 34 may be selected to achieve desired mechanical properties. In various embodiments, the two pleated pre-preg sheets 34 may the same or different fiber orientations. In various embodiments, the two pleated pre-preg sheets 34 may be substantially identical or may be of different types. For example, both pleated pre-preg sheets 34 may be pre-preg fabric disposed at different fiber (weave) orientations. In some embodiments, both pleated pre-preg sheet 34 may be pre-preg unidirectional sheets disposed at different fiber orientations. In some embodiments, both pleated pre-preg sheet 34 may be Forged Molding Compound™ including at least some randomly oriented short (i.e., cut, non-continuous) fibers impregnated in a thermosetting resin. In some embodiments, a radially inner pleated pre-preg sheet 34 may be a carbon fiber Forged Molding Compound™ including at least some randomly oriented short (i.e., cut, non-continuous) fibers impregnated in a thermosetting resin, and a radially outer pleated pre-preg sheet 34 may be pre-preg fabric where continuous carbon fibers are arranged (woven) in a weave.

FIG. 12C shows an embodiment where a single pleated pre-preg sheet 34 is wrapped around longitudinal axis LA and sandwiched between two or more layers 26, which may be non-pleated pre-preg sheets 38. In various embodiments, one or both non-pleated pre-preg sheets 38 may be combined with a single-layer pleated pre-preg sheet 34. In some embodiments, one or both non-pleated pre-preg sheets 38 may be combined with two or more pleated pre-preg sheets 34 in a multi-layer arrangement. For example, one or more inner non-pleated pre-preg sheets 38 may be disposed radially inward of pleated pre-preg sheet(s) 34 and wrapped around longitudinal axis LA. For example, one or more outer non-pleated pre-preg sheets 38 may be disposed radially outward of pleated pre-preg sheet(s) 34 and wrapped around longitudinal axis LA.

The fiber orientations and the types of non-pleated pre-preg sheets 38 may be selected to achieve desired mechanical properties. In various embodiments, the two non-pleated pre-preg sheets 38 may the same or different fiber orientations. In various embodiments, the two non-pleated pre-preg sheets 38 may be substantially identical or may be of different types.

In reference to FIGS. 12A-12C, precursors 124, 224, 324 as shown may subsequently proceed to a compression molding step. Optionally, stitching may be applied to precursors 124, 224, 324 before compression molding as explained below.

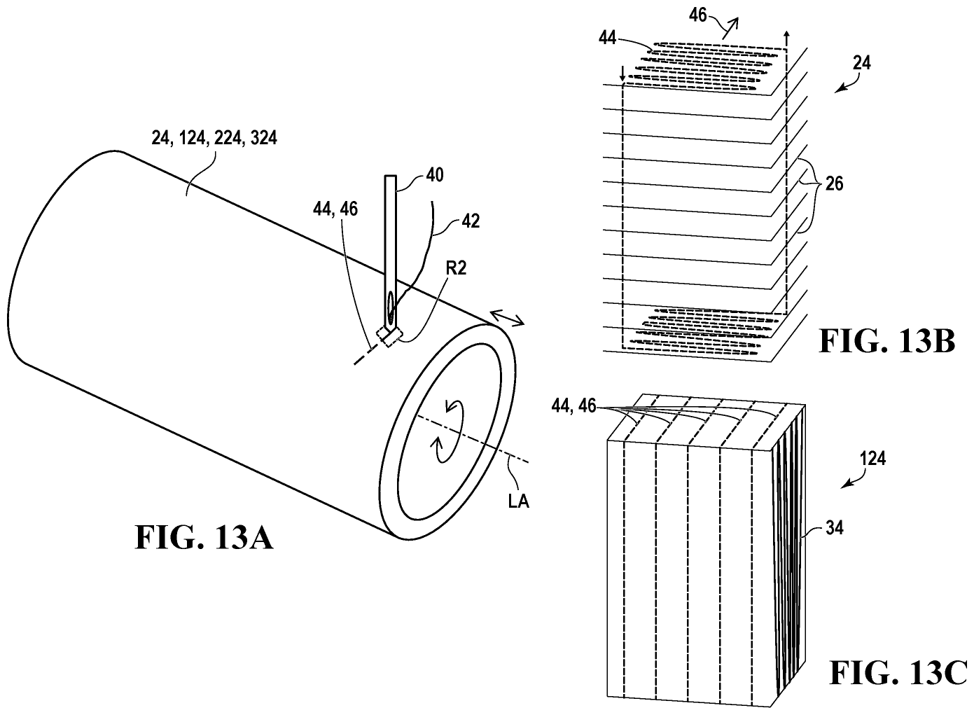

FIGS. 13A-13C schematically illustrate a stitching process that may be applied to any of precursors 24, 124, 224, 324 of spring 12 before compression molding (i.e., in the uncured state). Stitching may be performed by inserting needle 40, carrying the stitch thread 42, through a stack of layers 26 (e.g., pre-preg sheets) to form a 3D structure. Stitching may further strengthen the final structure of spring 12 after compression molding. In some embodiments, stitching of precursor 24, 124, 224, 324 may promote a improved resistance to torsional shear stresses that may be experienced by spring 12 during use. In various embodiments, stitch thread 42 may include a carbon fiber or a glass fiber for example. Stitching may be performed using one or more stitching patterns such as a straight stitch, triple stretch stitch, zigzag stitch, triple zigzag stitch, stretch zigzag stitch, blind hem stitch, shell tuck stitch, blanket stitch, ladder stitch, elastic overlock stitch, double overlock stitch, slant pin stitch, slant overlock stitch, feather stitch, tree stitch, fagoting stitch, honeycomb stitch, scallop stitch and bottonhole stitch for example.

Stitching may be performed using an industrial sewing machine such as those sold under the trade name VETRON. The sewing machine may be a multi-axis computer numerically controlled (CNC) sewing machine capable of manipulating (e.g., rotating, advancing, indexing) precursor 24, 124, 224, 324 relative to needle 40 during the stitching process. The sewing machine may be a “longarm” sewing machine. In some embodiments, precursor 24, 124, 224, 324 may be stitched while disposed on sleeve 130 or off of sleeve 130 and before compression molding. Stitches 44 may be applied along stitch line 46. Stitches 44 may be applied from a radially outer side of precursor 24, 124, 224, 324.

FIGS. 13B and 13C are exemplary columnar sections through the wall of precursor 24 and 124 respectively taken at region R2 of FIG. 13A. In reference to FIG. 13B, stitches 44 may extend through a plurality of layers 26 to secure layers 26 together. In some embodiments, stitches 44 may extend through all or some of layers 26 to extend through the entire thickness T1 shown in FIGS. 12A-12C. In reference to FIG. 13C, stitches 44 may extend through pleated pre-preg sheet(s) 34. In some embodiments, stitches 44 may secure pleats 36 of pleated pre-preg sheet(s) 34 together.

FIG. 14A is a partial front view of an upper portion of spring 12 shown in FIGS. 2A-2C with stitch lines 46 shown thereon. In some embodiments, stitch lines 46 may be oriented to preserve the integrity of the remain stitches 44 after the material removal process that forms openings 18. For example, in embodiments where resilient member 20 is a coil having first helix angle α1 relative to longitudinal axis LA, stitch lines 46 may also be applied in a helical pattern having second helix angle α2 relative to longitudinal axis LA, which may be substantially equal to first helix angle α1 (i.e., α1=α2). In some embodiments, this may permit spring 12 to have complete stitch lines 46 that extend continuously around spring 12 and that are not interrupted by openings 18.

FIG. 14B is an enlarged view of region R3 in FIG. 14A to schematically show an exemplary plain weave of an outer layer 26 used in precursor 24 used to manufacture spring 12. In some embodiments, one or more layers 26 of precursor 24 may be oriented according to a preferred fiber orientation α3 to preserve the integrity of some fibers after the material removal process that forms openings 18. In the plain weave of FIG. 14B, the fabric is oriented so that weft 48 has a fiber orientation α3 relative to longitudinal axis LA, which may be substantially equal to first helix angle α1 and second helix angle α2 (i.e., α1=α2=α3). In some embodiments, this may permit spring 12 to have complete fibers (i.e., weft 48) that extend continuously around spring 12 and that are not interrupted by openings 18. In embodiments where layer(s) 26 include one or more UD sheets, some or all of such UD sheets may be oriented to have fiber orientation α3 so that some fibers may extend continuously around spring 12 and not be interrupted by openings 18. In various embodiments, helix angle α1, second helix angle α2 and fiber orientation α3 may be non-zero (i.e., greater than zero). In various embodiments, helix angle α1, second helix angle α2 and fiber orientation α3 may be between 10 degrees and 30 degrees.

FIG. 15 is a partial cross-sectional view of the upper portion of spring 12 taken along line 15-15 in FIG. 2A showing some stitches 44 therein. In various embodiments, stitches 44 may extend through some or an entirety of thickness T2 of the wall of spring 12. As shown in FIG. 15, resilient member 20 may have a coil configuration where a cross-sectional profile of the coil turns may be rectangular or square.

FIG. 16A is a schematic axial cross-sectional view of an exemplary compression molding apparatus 50 (referred hereinafter as “apparatus 50”) for performing a compression molding operation on tubular precursor 24. Apparatus 50 may include a mold including first (lower) mold portion 52A and second (upper) mold portion 52B cooperating with first mold portion 52B in a mating engagement along a plane to define a mold cavity 54 therebetween. In some embodiments, the mating plane of mold portions 52A, 52B may include and be parallel to longitudinal axis LA of mandrel 32.

Mandrel 32 with precursor 24 wrapped thereon may be inserted inside mold portions 52A, 52B and support precursor 24 within mold cavity 54. FIG. 16A shows mold portions 52A, 52B released from each other to define an opening to mold cavity 54. For example, second mold portion 52B may be movable along arrow A to close the mold by moving second mold portion 52B toward first mold portion 52A, and to open the mold by moving second mold portion 52B away from first mold portion 52A.

In some embodiments first mold portion 52A may be secured to a press such as the V-Duo™ vertical press manufactured by ENGEL™ Canada Inc., for accepting the mandrel 32 and precursor 24 wrapped therearound. In some embodiments, first mold portion 52A may be considered to be a stationary die.

In some embodiments, second mold portion 52B may be removable from the press to facilitate insertion and removal of mandrel 32 and precursor 24 into and out of first mold portion 52A. In some embodiments second mold portion 52B may be considered a moving die.

Mandrel 32 and precursor 24 may also be movable along arrow A when the mold is open. For example, opening the mold may permit mandrel 32 and precursor 24 to be inserted into the mold by lowering mandrel 32 and precursor 24 into first mold portion 52A in preparation for compression molding. Opening the mold may also permit mandrel 32 and precursor 24 to be removed (released) from the mold by raising mandrel 32 and precursor 24 out of first mold portion 52A after compression molding. In some embodiments, a suitable shuttle may be provided to facilitate the movement of mandrel 32 and precursor 24 in and our of the mold.

Apparatus 50 may also include heat source 56 for transferring heat to precursor 24 during the compression molding (i.e., thermopressing) to assist with the consolidation (e.g., curing) of precursor 24. Heat H from heat source 56 may be transferred to precursor 24 via mandrel 32 and/or via one of both mold portions 52A, 52B. In some embodiments, heat source 56 may include electric heating elements embedded into or otherwise in thermal communication with mold portions 52A, 52B and/or mandrel 32. In some embodiments, heat source 56 may include one or more heated platens that are in conductive heat transfer engagement with one or more mold portions 52A, 52B for example. In some embodiments, heat source 56 may include a heat carrying fluid (e.g., oil, liquid water, steam) that is conveyed through one or more passages 71 formed in mold portions 52A, 52B and/or one or more passages (not shown) in mandrel 32. Mold portions 52A, 52B and mandrel 32 may be made from a metallic material such as steel, aluminum, or from a composite material.

In some embodiments, mandrel 32 may have central rod 60 extending substantially coaxially with longitudinal axis LA and protruding axially beyond the molding surface of mandrel 32 and hence axially beyond precursor 24. Rod 60 may engage in a mating fit with one or more cooperating recesses formed in first mold portion 52A and/or second mold portions 52B. Rod 60 may facilitate registration of the mandrel 32 and precursor 24 within mold cavity 54 to facilitate a repeatable and optionally uniform wall thickness of spring 12. Rod 60 may also facilitate manual handling of mandrel 32 to insert and remove mandrel 32 into or from first mold portion 52A.

FIG. 16B is a schematic axial cross-sectional view of apparatus 50 showing mold portions 52A, 52B in a closed state during compression molding. Precursor 24 and mold cavity 54 may be sized to define a compression fit when mold portions 52A and 52B are closed together so that precursor 24 may occupy substantially the entire mold cavity 54 after compression molding 54.

During compression molding, pressure and heat may be applied to precursor using mold portions 52A, 52B and heat source 56. Compression molding may cause melting of the matrix material and/or activation an epoxy-type matrix material. Mold portions 52A, 52B may release air from precursor 24 during compression molding so that the wall thickness T of precursor 24 after compression molding may be smaller than the wall thickness before compression molding. In embodiments where precursor 24 includes a plurality of layers 26, the compression molding may cause the plurality of layers 26 to fuse together to form a structure substantially without knit lines.

In some embodiments, mandrel 32 may have an optional chamfered axial end 58 or an axial end that otherwise has a reduced section to provide a thickened/reinforced region of spring 12 suitable for some applications and installation constraints. In some embodiments, mandrel 32 may be axially tapered so that the resulting spring 12 may also be tapered. In some embodiments, a radially outer surface of mandrel 32 may be slightly axially tapered by a draft angle to facilitate removal of precursor 24 from mandrel 32 by axially sliding precursor 24 from mandrel 32 along longitudinal axis LA.

FIG. 16C is a schematic transverse cross-sectional view apparatus 50 of FIG. 16A showing mold portions 52A, 52B in the closed state during compression molding. Mold portions 52A, 52B and mandrel 32 may define mold cavity 54 (and eventual spring 12) having desired inner and outer cross-sectional profiles as shown in springs 12, 112, 212, 312, 412 shown in FIGS. 2A-6C. In various embodiments, mold cavity 54 may have a circular or polygonal inner cross-sectional profile. In some embodiments. In various embodiments, mold cavity 54 may have a circular or polygonal outer cross-sectional profile. In various embodiments, mold cavity 54 may have an elliptical, triangular, quadrangular, pentagonal, hexagonal or octagonal inner and/or outer cross-sectional profiles. In some embodiments, the outer cross-sectional profile of mold cavity 54 may correspond to the final outer cross-sectional profile of spring 12. In some embodiments, the inner cross-sectional profile of mold cavity 54 may correspond to the final inner cross-sectional profile of spring 12.

FIG. 17 is a perspective view of tubular precursor 24 of spring 12 shown together with sleeve 130 and mandrel 132 used during compression molding of precursor 24. In apparatus 50 or in apparatus 150 shown in FIGS. 18A-18D, the uncured precursor 24 may be prepared on (e.g., wrapped around) directly on mandrel 32 or on optional sleeve 130. The use of multiple sleeves 130 may promote an increased production rate by allowing a plurality of uncured precursors 24 to be prepared simultaneously without occupying mandrel 132 or the mold. The use of sleeve 130 may also facilitate the installation of the uncured precursor 24 on mandrel 132. Once the uncured precursor 24 has been prepared on sleeve 130, sleeve 130 may be axially slid over mandrel 132.

In some embodiments where heat H is provided to precursor 24 via mandrel 132, sleeve 130 may be made from a (e.g., metallic) material (e.g., aluminum alloy) having a relatively high thermal conductivity. Sleeve 130 and mandrel 132 may be sized to permit relative sliding while maintaining a relatively close fit to promote conductive heat transfer from mandrel 132 to precursor 24 via sleeve 130. In other words, sleeve 130 may be in a conductive heat transfer engagement with mandrel 132 when installed over mandrel 132.

FIG. 18A is a schematic axial cross-sectional view of another exemplary compression molding apparatus 150 for compression molding of tubular precursor 24 where mold portions 152A, 152B of apparatus 150 are shown in an open state. Apparatus 150 may include elements of apparatus 50 previously described above. Like elements are identified using reference numerals that are incremented by 100. In contrast with apparatus 50, apparatus 150 may be configured to be used with sleeve 130, and mandrel 132 may be pivotally connected to second mold portion 152A so that mandrel 132 is rotatable about pivot axis PA that is transverse to longitudinal axis LA of mandrel 132.

In some embodiments, first mold portion 152A may be stationary and second mold portion 152B may be movable along arrow A to open and close the mold defined by mold portions 152A, 152B. In some embodiments, actuator 162 may be operatively connected to second mold portion 152B to cause movement of second mold portion 152B along arrow A and to apply sufficient force when second mold portion 152A is pushed toward first mold portion 152A during compression molding.

Apparatus 150 may include third mold portion 152C cooperating with first mold portion 152A and second mold portion 152B to define mold cavity 154. Third mold portion 152C may be movable along arrow B to permit rotation of mandrel 132 about pivot axis PA. In some embodiments, actuator 164 may be operatively connected to third mold portion 152C to cause movement of third mold portion 152C along arrow B. When mandrel 132 is rotated to the compression molding position, third mold portion 152C may be movable along longitudinal axis LA of mandrel 132 to selectively lock and release mandrel 132 from the compression molding position. In other words, arrow B may be parallel to longitudinal axis LA when mandrel 132 is in the compression molding position shown in FIG. 18C.

In some embodiments, actuator 166 may be operatively connected to mandrel 132 to cause rotational movement of mandrel 132 along arrow C and about pivot axis PA. Mandrel 132 may be pivotally connected to first mold portion 152A via a pin 168 defining a pivot or hinge about pivot axis PA. The rotation of mandrel 132 along arrow C may permit the installation (i.e., fitting) of sleeve 130 and uncured precursor 24 over mandrel 132 and the removal of sleeve 130 and cured precursor 24 from mandrel 132 after compression molding. The installation and removal of sleeve 130 from mandrel 132 may be performed by sliding sleeve 130 along longitudinal axis LA relative to mandrel 132. Actuators 162, 164, 166 may be hydraulic, pneumatic or electric actuators.

Apparatus 150 may also include heat source 156 for transferring heat to precursor 24 during the compression molding to assist with the consolidation (e.g., curing) of precursor 24. Heat H from heat source 156 may be transferred to precursor 24 via mandrel 132 and/or via one of both mold portions 152A, 152B. In some embodiments, heat source 156 may include electric heating elements embedded into or otherwise in thermal communication with mold portions 152A, 152B and/or mandrel 132. In some embodiments, heat source 156 may include a heat carrying fluid (e.g., oil, liquid water, steam) that is conveyed through one or more passages 171 formed in mold portions 152A, 152B and/or one or more passages 170 formed in mandrel 132. Mandrel 132 may include central rod 160.

FIG. 18B is a schematic axial cross-sectional view of apparatus 150 in a state of preparation for compression molding precursor 24. Precursor 24 and sleeve 130 have been installed on mandrel 132 and mandrel 132 has been rotated about pivot axis PA into the compression molding position. Third mold portion 152C has also been moved toward the right hand side and toward mandrel 132.

FIG. 18C is a schematic axial cross-sectional view of apparatus 150 in a state where compression molding of precursor 24 is occurring. Second mold portion 152B has been lowered and pressed against first mold portion 152A while precursor 24 is inside the mold. As pressure is applied to precursor 24, heat H is also supplied to precursor 24 by heat source 156. Heat source 156 may include a heat-carrying fluid circulating in passages 170 and 171.

FIG. 18D is a schematic axial cross-sectional view of apparatus 150 after compression molding of precursor 24 is complete. FIG. 18D illustrates a process of releasing mandrel 132 from the mold. Second mold portion 152B may be moved away from first mold portion 152A. Third mold portion 152C may be moved toward the left hand side to allow the left axial end of mandrel 132 to be rotated upward about pivot axis PA. Once mandrel 132 has been rotated to the position shown in FIG. 18A, sleeve 130 and precursor 24 may be slid off of mandrel 132. The cured precursor 24 may then be removed from sleeve 130 by axially sliding precursor 24 from sleeve 130. In some embodiments, the radially outer surface of sleeve 130 may be slightly axially tapered by a draft angle to facilitate removal of precursor 24 from sleeve 130 by axially sliding precursor 24 from sleeve 130 along longitudinal axis LA.

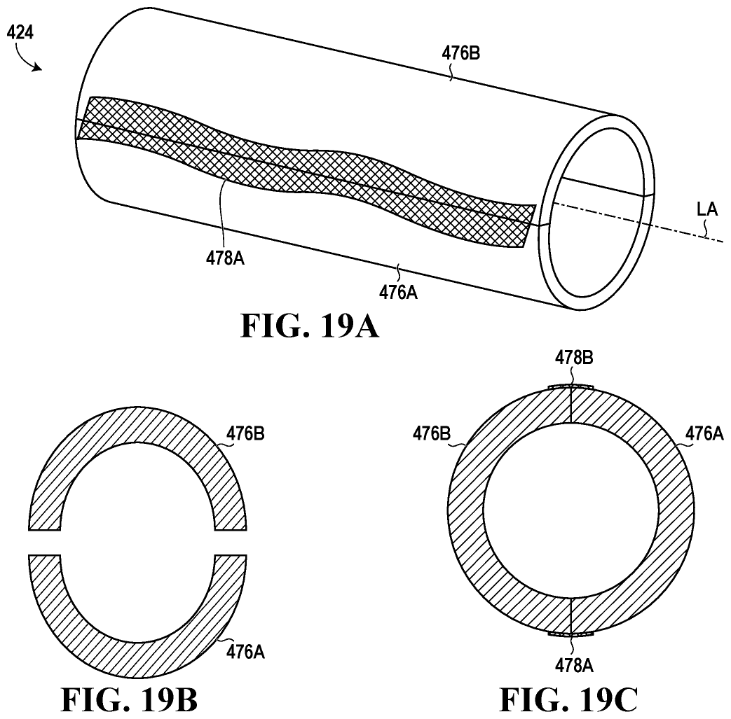

FIG. 19A is a perspective view of another exemplary tubular precursor 424 formed from two halves referenced as thermosets 476A, 476B that are compression molded together and optionally further secured together with one or more adhesive bonding patches 478A, 478B. Precursor 424 may be manufactured without the use of mandrel 32, 132. For example, instead of wrapping layers 26 around a mandrel, a plurality of mating pre-peg thermosets 476A, 476B may be prepared separately and then compression molded together. In some embodiments, thermosets 476A, 476B may each have a half-cylindrical (e.g., U-shaped) profile of substantially constant thickness along longitudinal axis LA. In some embodiments, mating edges of thermosets 476A, 476B may be sealed with respective adhesive bonding patches 478A, 478B.

FIG. 19B show the orientation of first thermoset 476A and second thermoset 476B in preparation for compression molding. First thermoset 476A may be placed inside a lower mold portion of a mold. Thereafter, second thermoset 476B may be disposed on top of first thermoset 476A, such that mating surfaces thereof are substantially aligned and in a mating engagement. The positioning of first thermoset 476A and second thermoset 476B in this way may define the annular shape of precursor 424.

FIG. 19C show the orientation and relative positioning of first thermoset 476A and second thermoset 476B during compression molding. Prior to compression molding, first thermoset 476A and second thermoset 476B may be rotated (e.g., by 90 degrees) about longitudinal axis LA and inside of the mold so that the seam between first thermoset 476A and second thermoset 476B does the coincide with a mating plane or line between the upper and lower mold portions. In some embodiments, the axial ends of first thermoset 476A and second thermoset 476B may be maintained in mating relationship by interlocking elements such as dovetails and pins for example. In some embodiments, the axial ends of first thermoset 476A and second thermoset 476B may be maintained in mating relationship by one or more adhesive bonding patches 478A, 478B.

The use of a non-mandrel technique may allow further flexibility in geometric features that can be incorporated into precursor 424. For example, such technique may permit opposite axial ends of precursor to be tapered to have an increased wall thickness since removal of precursor 424 by sliding off a mandrel is not required.

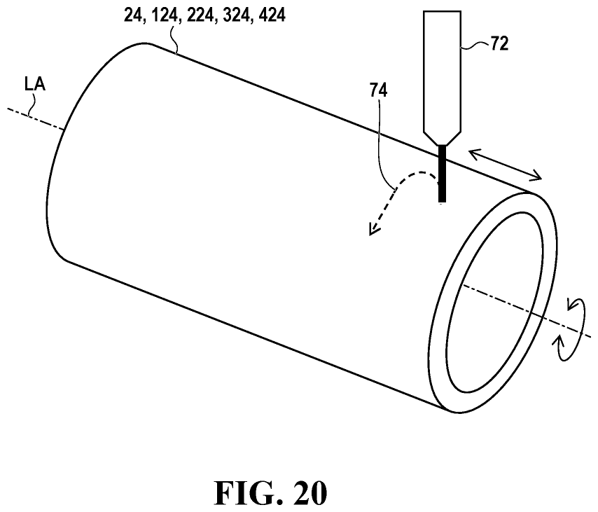

FIG. 20 is a perspective view of the cured tubular precursor 24 after compression molding and during a subtractive manufacturing process for removing material from precursor 24 and thereby form openings 18 in spring 12. In some embodiments, water jet cutting may be used to cut openings 18 into precursor 24. For example, water jet cutter 72 may be programmed to follow cutting tool path 74 defining one or more outlines of one or more openings 18 to be formed in spring 12. In some embodiments, water jet cutter 72 may be CNC controlled using a tool path derived from a computer aided design (CAD) model of spring 12.

In some embodiments, tool path 74 may be configured to produce a single continuous coil as resilient member 20. In some embodiments, tool path 74 may be configured to produce a multiple-start continuous coil such as a double-start continuous coil or a triple-start continuous coil for example. In some embodiments, tool path 74 may be configured to produce a cellular structure as described above.

Other subtractive manufacturing process(es) may be used instead of or in addition to water jet cutting. For example, other (e.g., laser) cutting, turning, machining (e.g., milling), etching and grinding may be used to form spring 12 from the cured precursor 24. In some embodiments, subtractive manufacturing process(es) may be performed on the fully cured precursor 24 so that no further curing of precursor 24 is necessary after the subtractive manufacturing process(es). In some embodiments, one or more subtractive manufacturing process(es) may be used to adjust the inner and or outer transverse cross-sectional profiles of precursor 24, and/or to trim an axial length of precursor 24 for example.

In some situations, manufacturing time may be reduced by performing tasks in parallel. For example, through the use of multiple sleeves 130, the steps of wrapping of the uncured precursor 24, compression molding and subtractive manufacturing may be performed in parallel on different precursors 24. In some embodiments, when performing the manufacturing tasks in parallel, the total cycle time to manufacture spring 12 may be in the order of 2-3 minutes.

The mechanical and dynamic properties of spring 12 may be tailored by the selection of the location and extent of the material removed from the cured precursor 24. For example, through experimentation, simulation and/or modeling (e.g., finite element analysis), geometric parameters of spring 12 such as the location, orientation, thickness and spacing of the material left intact in spring 12 may be determined to achieve desired properties. For a resilient member 20 having a coil configuration, such geometric parameters may include a width of a strip (e.g., having a rectangular cross-section) of material removed, an inner diameter, an outer diameter, a spacing between adjacent turns in the coil, the number of turns, and a helix angle α1 of turns relative to longitudinal axis LA for example.

As can be seen therefore, the examples described above and illustrated are intended to be exemplary only. The scope is indicated by the appended claims.

1. A composite spring for a vehicle suspension, the composite spring comprising:
a tube made from a fiber-reinforced composite material and having a longitudinal axis, the tube including:
a first axial end having a closed shape that completely surrounds the longitudinal axis;
a second axial end axially opposite the first axial end relative to the longitudinal axis; and
one or more openings formed through a wall of the tube and disposed axially between the first axial end and the second axial end, a portion of the wall adjacent the one or more openings defining a resilient member of the spring.

2. The composite spring as defined in claim 1, wherein the resilient member is a coil.

3. The composite spring as defined in claim 1, wherein the one or more openings define a cellular structure and the resilient member is part of the cellular structure.

4. (canceled)

5. The composite spring as defined in claim 1, wherein the tube has a circular radially-inner profile when viewed along the longitudinal axis.

6. The composite spring as defined in claim 1, wherein the tube has a circular radially-outer profile when viewed along the longitudinal axis.

7. The composite spring as defined in claim 1, wherein the tube has a non-circular radially-outer profile when viewed along the longitudinal axis.

8. (canceled)

9. The composite spring as defined in claim 1, wherein the tube has a non-circular radially-inner profile when viewed along the longitudinal axis.

10. (canceled)

11. (canceled)

12. The composite spring as defined in claim 1, wherein:
the closed shape is a first closed shape; and
the second axial end has a second closed shape that completely surrounds the longitudinal axis.

13. (canceled)

14. (canceled)

15. The composite spring as defined in claim 1, wherein:
the wall of the tube includes a plurality of stacked layers of fibers wrapped around the longitudinal axis; and
the layers are stitched together.

16. The composite spring as defined in claim 15, wherein:
the resilient member is a coil;
the coil has first helix angle; and
the layers are stitched together along a stitch line having a second helix angle substantially equal to the first helix angle.

17. The composite spring as defined in claim 15, wherein the fibers are arranged in a weave in at least one of the layers.

18. The composite spring as defined in claim 1, wherein the wall of the tube includes a pleated sheet of fibers wrapped around the longitudinal axis.

19. The composite spring as defined in claim 18, wherein one or more pleats of the pleated sheet are oriented at least partially radially relative to the longitudinal axis.

20. The composite spring as defined in claim 18, wherein:
the pleated sheet of fibers is a first pleated sheet of fibers; and
the wall of the tube includes a second pleated sheet of fibers overlaying and meshing with the first pleated sheet of fibers.

21. The composite spring as defined in claim 18, wherein the wall of the tube includes an outer non-pleated sheet of fibers disposed radially outward of the pleated sheet of fibers and wrapped around the longitudinal axis.

22. The composite spring as defined in claim 18, wherein the wall of the tube includes an inner non-pleated sheet of fibers disposed radially inward of the pleated sheet of fibers and wrapped around the longitudinal axis.

23. The composite spring as defined in claim 18, wherein the wall of the tube includes a plurality of stiches extending through the pleated sheet of fibers.

24. (canceled)

25. A vehicle including the composite spring defined in claim 1.

26. A method of manufacturing a composite spring, the method comprising:
forming a tubular precursor from fiber-reinforced composite material; and
using a subtractive manufacturing process to form one or more openings through a wall of the tubular precursor to define a resilient member of the spring.

27. The method as defined in claim 26, wherein the subtractive manufacturing process includes water jet cutting.

28. The method as defined in claim 26, wherein forming the tubular precursor includes:
wrapping a pleated sheet of fibers pre-impregnated with a matrix material around a holder; and
compression molding the pleated sheet to form the tubular precursor.

29. The method as defined in claim 28, wherein:
the pleated sheet is a first pleated sheet of fibers; and
the method includes:
wrapping a second pleated sheet of fibers pre-impregnated with the matrix material around the holder so that the second pleated sheet overlays and meshes with the first pleated sheet; and
compression molding the first pleated sheet and the second pleated sheet together to form the tubular precursor.

30. (canceled)

31. The method as defined in claim 28, wherein forming the tubular precursor includes wrapping an outer non-pleated sheet of fibers pre-impregnated with the matrix material around the holder and radially outward of the pleated sheet before the compression molding.

32. The method as defined in claim 28, wherein forming the tubular precursor includes wrapping an inner non-pleated sheet of fibers pre-impregnated with the matrix material radially inward of the pleated sheet before the compression molding.

33. The method as defined in claim 26, wherein forming the tubular precursor includes:
wrapping one or more layers of fibers pre-impregnated with a matrix material around a holder;
stitching the one or more layers; and
compression molding the one or more layers to form the tubular precursor.

34. (canceled)

35. The method as defined in claim 26, wherein forming the tubular precursor includes:
wrapping one or more layers of fibers pre-impregnated with a matrix material around a holder;
placing the holder with the one or more layers in a mold cavity by rotating a longitudinal axis of the holder about a pivot axis that is transverse to the longitudinal axis of the holder; and
compression molding the one or more layers to form the tubular precursor.

36. A compression molding apparatus for forming a tubular precursor to a composite spring, the compression molding apparatus comprising:
a first mold portion;
a second mold portion cooperating with the first mold portion to define a mold cavity, the first mold portion and the second mold portion being releasable from each other to open the mold cavity;
a mandrel for holding the tubular precursor wrapped around the mandrel inside the mold cavity, the mandrel having a longitudinal axis and being pivotally connected to the second mold portion so that the mandrel is rotatable about a pivot axis that is transverse to the longitudinal axis of the mandrel; and
a heat source for heating the tubular precursor during compression molding of the tubular precursor.

37. The compression molding apparatus as defined in claim 36, wherein:
the heat source includes a heat-carrying fluid; and
the mandrel includes a passage formed therein for conveying the heat-carrying fluid.

38. The compression molding apparatus as defined in claim 36, comprising a metallic sleeve for holding the tubular precursor, the metallic sleeve being configured to be fitted over the mandrel and be disposed between the tubular precursor and the mandrel.

39. (canceled)

40. The compression molding apparatus as defined in claim 36, comprising a third mold portion cooperating with the first mold portion and the second mold portion to define the mold cavity, the third mold portion being movable along the longitudinal axis of the mandrel to selectively lock and release the mandrel from a compression molding position.

41. A tubular manufacturing precursor to a composite spring, the precursor comprising a plurality of layers of fibers pre-impregnated with a matrix material and wrapped around an elongated holder having a longitudinal axis, the plurality of layers being stitched together.

42. The tubular manufacturing precursor as defined in claim 41, wherein the plurality of layers are stitched together along a stitch line having a non-zero helix angle relative to the longitudinal axis.

43. The tubular manufacturing precursor as defined in claim 42, wherein at least one of the plurality of layers has fibers that are oriented at the non-zero helix angle relative to the longitudinal axis.

44. The tubular manufacturing precursor as defined in claim 41, wherein at least one of the plurality of layers is pleated.

45. A tubular manufacturing precursor to a composite spring, the precursor comprising a pleated sheet of fibers pre-impregnated with a matrix material and wrapped around an elongated holder having a longitudinal axis, the pleated sheet having a plurality of pleats oriented substantially radially relative to the longitudinal axis.

46. The tubular manufacturing precursor as defined in claim 45, wherein:
the pleated sheet is a first pleated sheet; and
the tubular manufacturing precursor includes a second pleated sheet of fibers pre-impregnated with the matrix material and wrapped around the elongated holder, the second pleated sheet overlaying and meshing with the first pleated sheet.

47. The tubular manufacturing precursor as defined in claim 45, wherein the pleated sheet is sandwiched between:
an outer non-pleated sheet of fibers pre-impregnated with the matrix material, disposed radially outward of the pleated sheet and wrapped around the longitudinal axis; and
an inner non-pleated sheet of fibers pre-impregnated with the matrix material, disposed radially inward of the pleated sheet of fibers and wrapped around the longitudinal axis.
